(19) United States
(12) Patent Application Publication
(10) Pub. No.: US 2008/0091610 A1
(43) Pub. Date: Apr. 17, 2008

(54) Fully-embedded commercial transaction using an unobtrusive presentation without click-through

(75) Inventor: Yobie Benjamin, Fremont, CA (US)

Correspondence Address: Raj Abhyanker, LLP;c/o Intellevate, P.O. Box 52050, Minneapolis, MN, 55402, US

(73) Assignee: Goodstorm, Inc.

(21) Appl. No.: 11/542,927

(22) Filed: Oct. 3, 2006

(51) Int. Cl. H04L 9/00

(52) U.S. Cl. 705/52

(57) ABSTRACT

A fully-embedded commercial transaction using an unobtrusive presentation without click-through is disclosed. In one embodiment, a method of a media module of a distributor module includes generating a custom media playlist on a space adjacent to a content data associated with a profile of a patron of a publisher module having the content data, configuring the custom media playlist based on a preference data of the patron, and enabling a transaction of a particular item of the custom media playlist without leaving the space.

In another embodiment, a method of a delivery module of a distributor module includes embedding a commerce engine having a manifestation of an offering in a message portion of an electronic message, communicating the electronic message to a recipient, and enabling the recipient to transact the offering directly in the message portion of the electronic message without being redirected to another location.

### CLAIM OF PRIORITY

This application claims priority form the non-provisional application Ser. No. 11/448,219 titled “Charisma monetization through an integrated and reusable commerce engine” filed on Jun. 7, 2006

### FIELD OF TECHNOLOGY

This disclosure relates generally to the technical fields of software and/or hardware technology and, in one example embodiment, to fully-embedded commercial transaction using an unobtrusive presentation without click-through.

### BACKGROUND

An online diary (e.g., a personal blog, an online journal, etc.) may be a diary and/or a journal that is published on a website and/or a site hosting the online diary of a world wide web. In a content of the online diary, a diarist (e.g., a blogger) may write social and/or political commentaries, compositions, day-to-day thoughts, and/or other types of contents. The diarist who may devote a significant amount of his/her time in preparing and managing the website having the online diary may find it difficult to sustain the website when the diarist may not have a financial means to do so.

Patrons of the website having the online diary may sympathize with the diarist who may find it difficult to sustain the website (e.g., because of a lack of time, financial supports, etc). On the other hands, the patrons may resent to an idea of the website hosting an outside vendor (e.g., through linking a vendor website of the outside vendor to the website) because a merchandise (e.g., an apparel, a music file, a book, etc.) of the outside vendor may not coincide a sprit (e.g., look and/or feel) of the website.

In addition, the outside vendor may not be capable of accommodating (e.g., through giving choices to the patrons) the patrons' needs because the merchandise may not be modified based on a criterion of the patrons. The merchandise may be incompatible to tastes of the patrons and/or incongruent with a theme of the website.

Furthermore, the patrons who may be subscribing to the outside vendor may be moved to a different network location (e.g., a network address) of the vendor website of the outside vendor. This may slow down a speed of transacting the merchandise because it may take time to move to the different network location (e.g., moving from a page view of the website to a page view of the vendor website). The patrons may also be turned off by an experience of having to type a network address of the website and/or clicking a “backward” button of a current page view of the vendor website to return to the website having the online diary (e.g., when a transaction at the vendor website is completed).

### SUMMARY

A fully-embedded commercial transaction using an unobtrusive presentation without click-through is disclosed. In one aspect, a method of a media module of a distributor module includes generating a custom media playlist on a space adjacent to a content data associated with a profile of a patron of a publisher module having the content data. The method also includes configuring the custom media playlist based on a preference data (e.g., where the preference data is at least one of a genre data, a topliner data, a period data, a popularity data, and an other data) of the patron, and enabling a transaction of a particular item of the custom media playlist without leaving the space adjacent to the content data.

The method may further include providing a sample data of the particular item of the custom media playlist to the patron to increase a frequency of instances of the transaction of the particular item of the custom media playlist. Also, the method may include providing a plurality of music files to the patron based on the preference data of the patron using a jukebox module of the media module. Moreover, the method may include spurring (e.g., inciting and/or stimulating) the frequency of instances of the transaction when at least one of the transaction of the particular item is associated with a charismatic influence of the publisher module, wherein a profit of the transaction to be shared between the publisher module and the distributor module. Furthermore, the method may include providing a plurality of movie files to the patron based on the preference data of the patron using a multiplex module of the media module.

In another aspect, a method of a merchandise module of a distributor module includes generating a representation of a customizable merchandise item on a location adjacent to a content data of a publisher module based on a criterion of the publisher module. The method also includes stylizing the customizable merchandise item using a filter based on a choice data (e.g., where the choice data is at least one of a type data, a size data, a graphic data and a text data) of a patron of the publisher module, and processing a transaction of the customizable merchandise item while fully preserving the transaction in the location adjacent to the content data.

The method may further include expanding a pool of the choice data based on a contribution of the graphic data and the text data of the patron using a contribution module of the merchandise module. In addition the method may include enabling the patron to uniquely design a t-shirt based on the choice data using a t-shirt module of the merchandise module. Moreover, the method may include promoting an instance of the transaction of the customizable merchandise item when the patron of the t-shirt module purchases the customizable merchandise item based on a charismatic influence of the publisher module. Furthermore, the method may include enabling the patron to particularly design a mug based on the choice data using a mug module of the merchandise module.

In yet another aspect, a method of a delivery module of a distributor module includes embedding a commerce engine having a manifestation of an offering in a message portion of an electronic message. The method also includes communicating the electronic message to a recipient, and enabling the recipient to transact the offering directly in the message portion of the electronic message without being redirected to another location away from the message portion of the electronic message.

The method may further include embedding the commerce engine having the manifestation of the offering in an attachment of the electronic message, and embedding a digital signature on the message portion of the electronic message such that the recipient is assured of a security and a soundness in transacting the offering. In addition, the method may include sharing a profit of a transaction with a sender of the electronic message when the recipient of the electronic message makes the transaction based on a charismatic influence of the sender, wherein an existence of the charismatic influence is predetermined based on an agreement between the sender and the distributor module.

Moreover, the method may include enabling the recipient of the electronic message to forward the commerce engine to an acquaintance of the recipient such that the acquaintance makes a purchase of the offering without leaving the message portion of the electronic message. Furthermore, the method may include sharing a profit of the purchase between the recipient and the distributor module when the acquaintance makes the purchase of the offering, wherein the recipient signs up with the distributor module to participate in the sharing the profit before the purchase takes place. Also, the method may include performing the embedding the commerce engine having the manifestation of the offering such that the recipient customizes the offering based on a preference.

The methods, systems, and devices disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a network of admired parties each having an integrated reusable commerce engine provided through a charisma monetization module supported through a network of offering distributors, according to one embodiment.

FIG. 2 is an exploded view of the service provider module of FIG. 1, according to one embodiment.

FIG. 3 is an exploded view of the admired party module of FIG. 1, according to one embodiment.

FIG. 4 is a table view of content referenced by the profile database of FIG. 2, according to one embodiment.

FIG. 5 is a user interface view of the mark-up language page of FIG. 3 associated with the admired party module of FIG. 1, according to one embodiment.

FIG. 6 is a user interface view of the service provider module of FIG. 1, according to one embodiment.

FIG. 7 is a diagrammatic representation of a data processing system capable of processing a set of instructions to perform any one or more of the methodologies herein, according to one embodiment.

FIG. 8 is an interaction diagram of a process flow between the service provider module, the admired party module and the follower device of FIG. 1, according to one embodiment.

FIG. 9 is a process flow to provide a holistic commerce solution to an admired party, according to one embodiment.

FIG. 10 is a process flow to integrate a branded commerce engine provided by a third party, according to one embodiment.

FIG. 11 is a system view of a network of a distributor module and a publisher module, according to one embodiment.

FIG. 12 is an exploded view of the distributor module of FIG. 11, according to one embodiment.

FIG. 13 is an exploded view of an exploded view of the media module of FIG. 11, according to one embodiment.

FIG. 14 is an exploded view of the merchandise module of FIG. 11, according to one embodiment.

FIG. 15 is a user interface view of an electronic message associated with the electronic message module of FIG. 11, according to one embodiment.

FIG. 16 is a user interface view of the page view of FIG. 11 associated with the publisher module of FIG. 11, according to one embodiment.

FIG. 17 is a process flow to provide a transaction of a custom media playlist without leaving the publisher module of FIG. 1, according to one embodiment.

FIG. 18 is a process flow to process a transaction of a customizable merchandise item while fully preserving a network location of the publisher module of FIG. 1, according to one embodiment.

FIG. 19 is a process flow to enable a transaction of an offering in the body of the electronic message of FIG. 15, according to one embodiment.

Other features of the present embodiments will be apparent from the accompanying drawings and from the detailed description that follows.

### DETAILED DESCRIPTION

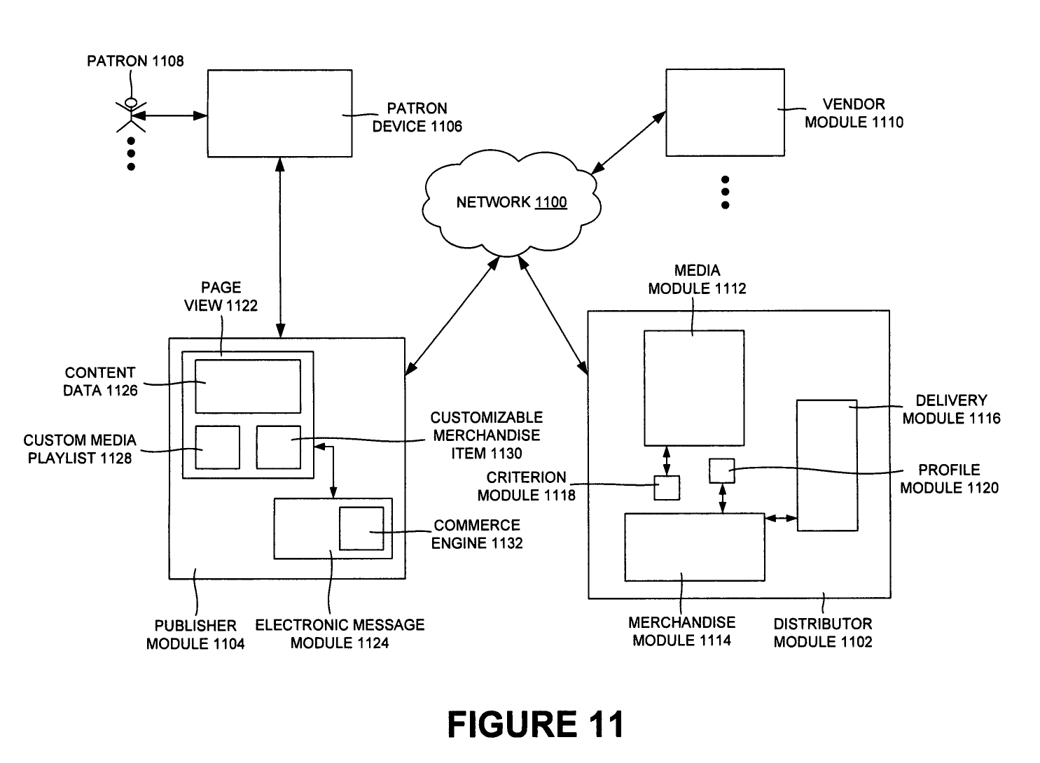

A fully-embedded commercial transaction using an unobtrusive presentation without click-through is disclosed. In one embodiment, a method of a media module (e.g., a media module 1112 of FIG. 11) of a distributor module (e.g., a distributor module 1102 of FIG. 11) includes generating a custom media playlist (e.g., a custom media playlsit 1128 of FIG. 11) on a space adjacent to a content data (e.g., a content data 1126 of FIG. 11) associated with a profile of a patron (e.g., a patron 1108 of FIG. 11) of a publisher module (e.g., a publisher module 1104 of FIG. 11) having the content data. The method also includes configuring the custom media playlist based on a preference data of the patron, and enabling a transaction of a particular item of the custom media playlist without leaving the space adjacent to the content data.

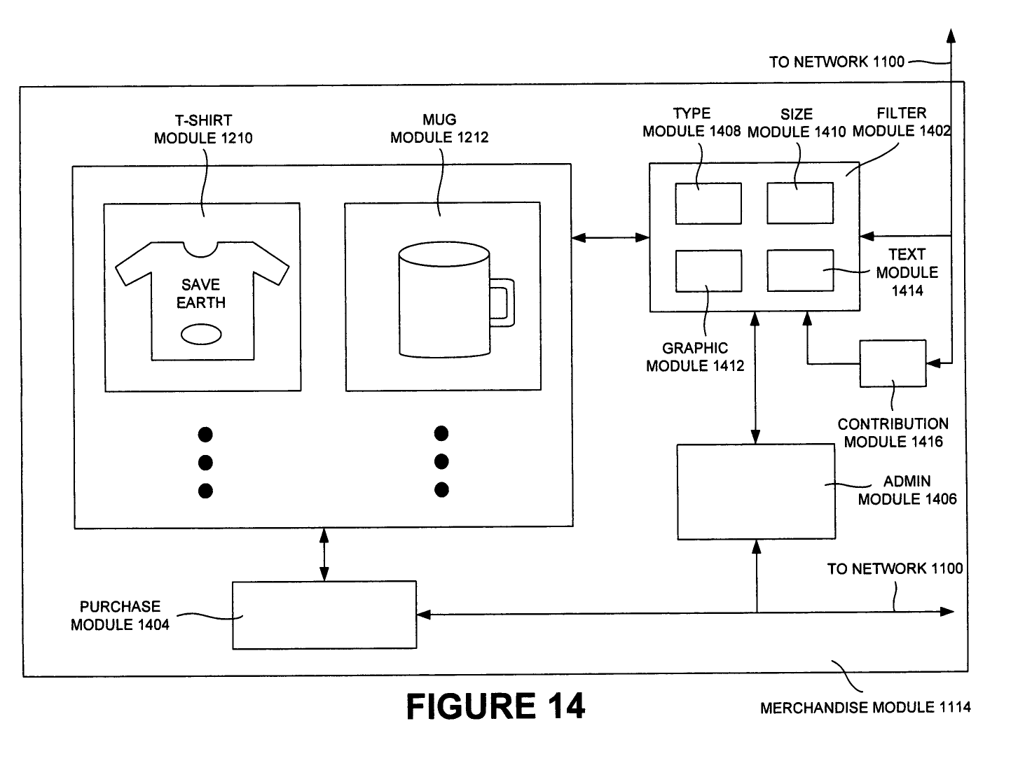

In another embodiment, a method of a merchandise module (e.g., a merchandise module 1114 of FIG. 11) of a distributor module (e.g., the distributor module 1102 of FIG. 11) includes generating a representation of a customizable merchandise item (a customizable merchandise item 1130 of FIG. 11) on a location adjacent to a content data (e.g., the content data 1126 of FIG. 11) of a publisher module (e.g., the publisher module 1104 of FIG. 11) based on a criterion of the publisher module. The method also includes stylizing the customizable merchandise item using a filter (e.g., a filter module 1402 of FIG. 14) based on a choice data of a patron (e.g., the patron 1108 of FIG. 11) of the publisher module, and processing a transaction of the customizable merchandise item while fully preserving the transaction in the location adjacent to the content data.

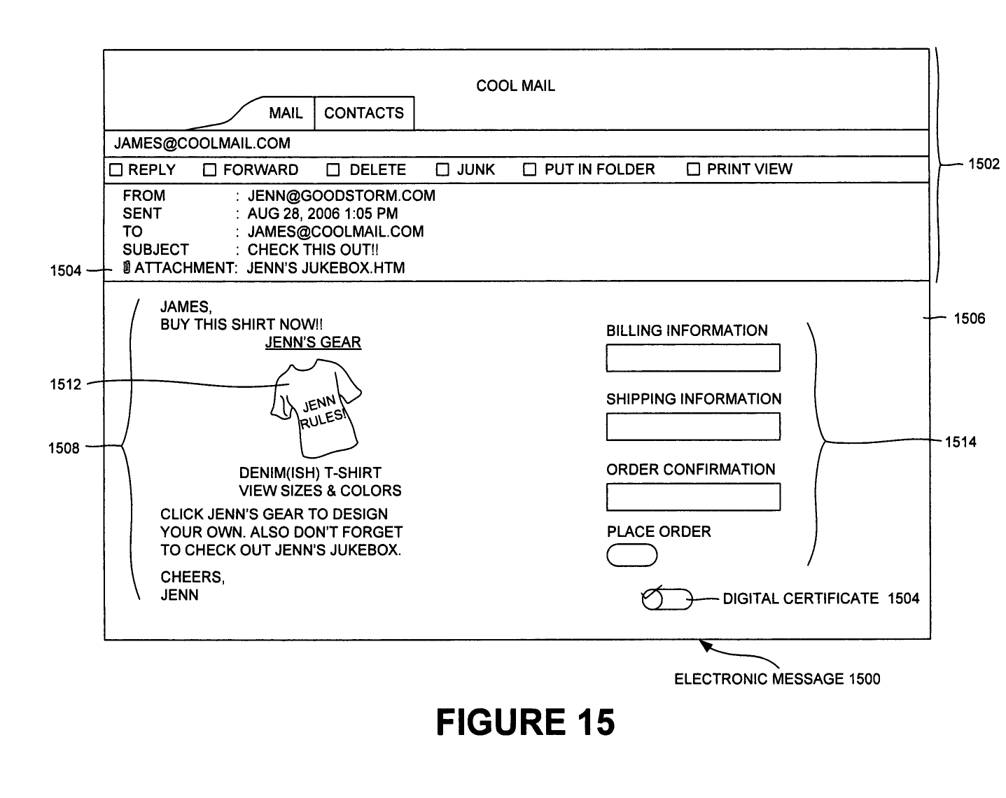

In yet another embodiment, a method of a delivery module (e.g., a delivery module 1116 of FIG. 11) of a distributor module (e.g., the distributor module 1102 of FIG. 11) includes embedding a commerce engine (e.g., a commerce engine 1132 of FIG. 11) having a manifestation of an offering in a message portion (e.g., a body 1506 of FIG. 15) of an electronic message (e.g., an electronic message 1500 of FIG. 15). The method also includes communicating the electronic message to a recipient, and enabling the recipient to transact the offering directly in the message portion of the electronic message without being redirected to another location away from the message portion of the electronic message.

Also, the method may be in a form of a machine-readable medium embodying a set of instructions that, when executed by a machine, cause the machine to perform any method disclosed herein. It will be appreciated that the various embodiments discussed herein may/may not be the same embodiment, and may be grouped into various other embodiments not explicitly disclosed herein.

It will be appreciated that the various embodiments discussed herein may/may not be the same embodiment, and may be grouped into various other embodiments not explicitly disclosed herein.

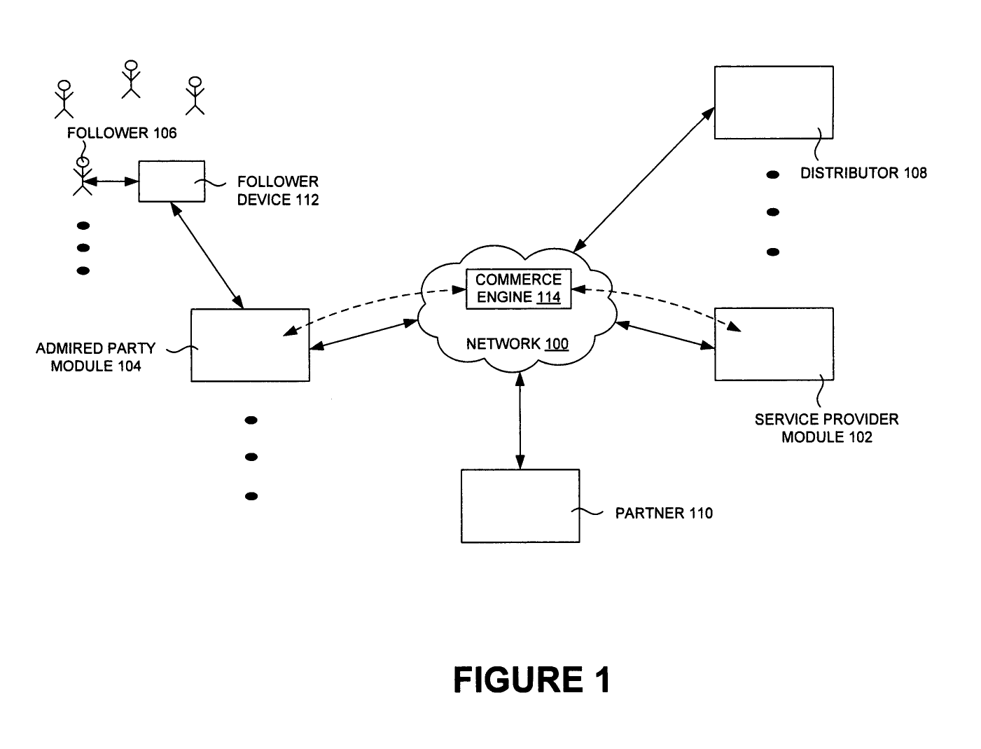

FIG. 1 is a system view of a network of admired parties, having a service provider module 102, an admired party module 104, a follower 106, a distributor 108, a partner 110, a follower device 112, and a commerce engine 114, which may communicate through a network 100 (e.g., internet). The service provider module 102 may provide a holistic commerce solution (e.g., a charisma monetization solution) to an admired party (e.g., associated with the admired party module 104) through an integration of an integrated, reusable and/or branded commerce engine (e.g., the commerce engine 114 may be provided by the service provider module 102) in a mark-up language page (e.g., a website, a blog, etc.) of the admired party.

The admired party may be any party (e.g., a person, a persona, a representative of a non-human entity) having a social, religious, political, virtual, personal etc. significance (e.g., a blogger, a celebrity, an artiste, a friend of another party, etc.) to another party (e.g., the follower 106). The follower 106 (e.g., a fan, a friend, a patron, a supporter etc. of the admired party associated with the admired party module 104) may communicate with the admired party module 104 (e.g., may visit a website of the admired party) through the follower device 112 (e.g., a desktop computer, a laptop, a PDA, a telecommunications device, etc.) to engage in a transaction (e.g., to purchase branded offerings, based on an empathy with and/or a charisma of, the admired party) through the mark up language portal associated with the admired party module 104.

For example, the branded offerings may be digital media offerings (e.g, digital music), physical offerings (e.g., apparel) and/or services (e.g., tickets, political message memorabilia, etc.). The transaction initiated by the follower 106 through the mark up language portal (e.g., using the commerce engine 114 associated with the admired party module 104 and/or provided by the service provider module 102) of the admired party may be at a price based on an empathy relationship between the follower 106 and the value (e.g., the interests, the cause, etc.) of the admired party. The transaction may be fulfilled based on a drop-ship (e.g., shipping to order) of the offerings to the follower 106, arranged through a network of distributors (e.g., such as the distributor 108 illustrated in FIG. 1) associated with the service provider module 102 (e.g., the service provider module 102 may maintain no inventory of the branded offerings) when the follower 106 purchases an offering on the mark-up language page of the admired party (e.g., and/or generated using the admired party module 104).

For example, the admired party may be a celebrity and/or a blogger (e.g., a web logger) who primarily provides a content-based information (e.g., on his/her website) without profiting from his/her popularity (e.g., independent of monetizing a brand identity associated with the admired party module 104). A growth of the brand identity (e.g., of the admired party) may be a result of a popularity of the content-based information in a geographic region.

The partner 110 may be a strategic, business and/or service partner (e.g., a social network provider, a relationship network, etc.) associated with the service provider module 102. For example, the partner 110 may be a friendship network of users having profiles listed on mark-up language pages in which the service provider module 102 may integrate commerce engines (e.g., the commerce engine 114 illustrated in FIG. 1) based on preferences set by the users (e.g., the users may be admired parties of other users) and/or the partner 110.

The commerce engine 114 may be a branded commerce engine (e.g., a program script, a code, a plug-in, a utility, etc.) integrated into the mark-up language page of the admired entity. The commerce engine 114 may provide the follower 106 of the admired party module 104 a complete process for selecting, reviewing and/or purchasing the branded offerings promoted on the mark-up language page of the admired party.

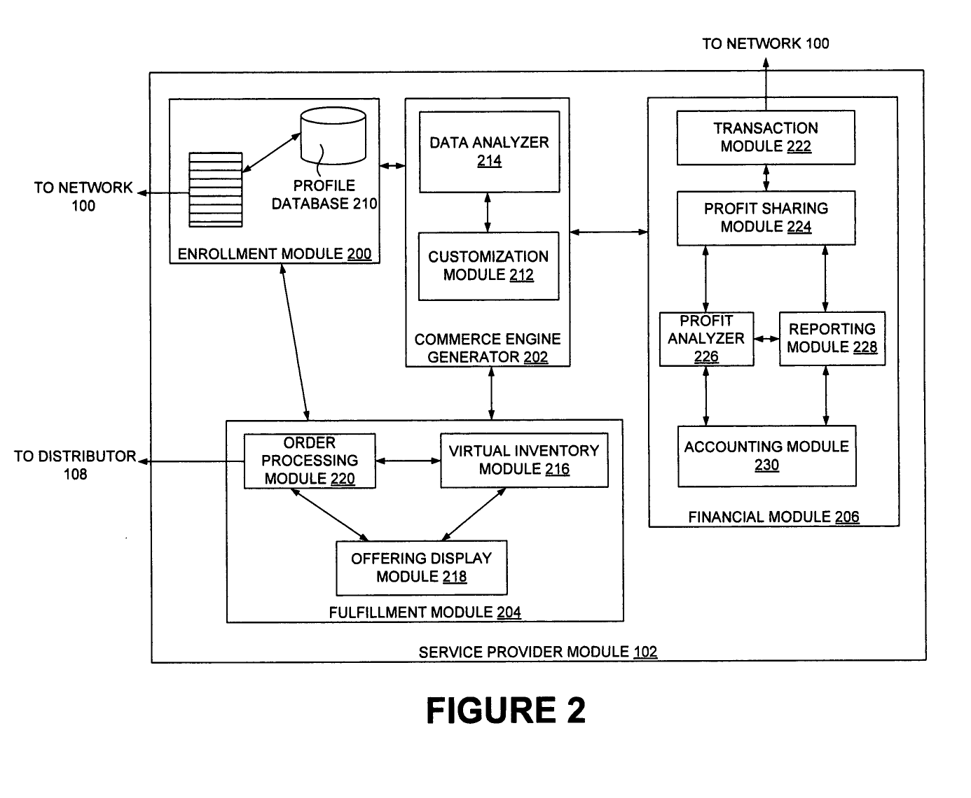

FIG. 2 is an exploded view of the service provider module 102 of FIG. 1, having an enrollment module 200, a commerce engine generator module 202, a fulfillment module 204 and/or a financial module 206, according to one embodiment. The enrollment module 200 may include an enrollment form 208 and/or a profile database 210. The commerce engine generator module 202 may include a customization module 212 and/or a data analyzer 214.

The fulfillment module 204 may include a virtual inventory module 216, an offering display module 218 and/or an order processing module 220. The financial module 206 may include a transaction module 222, a profit sharing module 224, a profit analyzer 226, a reporting module 228 and/or an accounting module 230. The enrollment module 200 may process (e.g., capture, generate, record, track, store, manage, etc.) an enrollment (e.g., an online signup) of the admired party (e.g., the admired party associated with the admired party module 104 of FIG. 1) with the service provider module 102 based on a profile of values (e.g., interests) of the admired party.

For example, the enrollment module 200 may process a value parameter specified by the admired party (e.g., based on a personal value, a political value, a religious value, a professional value, a social value and/or a controversial value, etc.) through the enrollment form 208 (e.g., a template of choices) communicated to the admired party (e.g., through the admired party module 104).

The value parameters associated with various admired party modules may be referenced (e.g., recorded, stored, tracked, etc.) by the profile database 210. The commerce engine generator module 202 may determine (e.g., generate, calculate, etc. using various algorithms, mapping processes and/or predefined settings, etc.) a customized commerce engine (e.g., the commerce engine 114 of FIG. 1) for the mark up language portal associated with the admired party module 104, through the customization module 212 and/or based on a communication with the enrollment module 200.

The customization module 212 may refresh the at least one offering on the mark-up language page of the admired party based on a change in the value parameter specified by the admired party (e.g., using the enrollment form 208). For example, the data analyzer 214 may communicate with the customization module 212 and/or the admired party module 104 to process (e.g., analyze, track, capture, etc.) the value parameters (e.g., the profile) communicated by the admired party module 104 to the enrollment module 200, and/or to process (e.g., facilitate) a synchronization (e.g., a modification, an update, a refreshing) of the customization module 212 and/or the enrollment module 200.

The fulfillment module 204 may process an end-to-end purchase to sale of the branded offering on behalf of the admired party associated with the admired party module 104. The virtual inventory module 216 may process (e.g., create, render, etc.) a virtual inventory (e.g., a stock of branded offerings visible in an online environment but not carried as physical inventory by the admired party module 104 or the service provider module 102) customized to the value parameter(s) of the admired party on the mark-up language page of the admired party (e.g., the branded offerings in the virtual inventory may be available for purchase to the follower 106 of the admired party using the commerce engine 114 integrated into the mark-up language page associated with the admired party module 104.

The offering display module 218 may process data and/or meta data associated with the display (e.g., through a graphical user interface) of the virtual inventory on the mark-up language page of the admired party module 104. In one embodiment, the offering display module 218 may enable the follower 106 of the admired party to perform a transaction (e.g., purchase branded offering using the integrated commerce engine of the admired party module 104) in its entirety without leaving a particular mark-up language page (e.g., website) when the transaction is initiated.

For example, the offering display module 218 may strip a web browser embodying the mark-up language page of header fields and disguise the browser as a flame embedded directly in the mark-up language page as a session-less pop-in to the mark-up language page (e.g., the follower 106 using the mark-up language page may perceive the transaction as taking place seamlessly in the same browser window). The follower 106 may be able to perform the entire transaction through a single click of a pointing device (e.g., a mouse) through an iframe technology (e.g., by embedding a document within another document) whereby the follower may be able to view and/or provide information (e.g., detailed product specification, buyer information, credit card information, shipping and/or handling information, etc.) in a single browser window embedded in the mark-up language page, without leaving the mark-up language page of the admired party module 104. The single browser window may have multiple panes (e.g., shipping information pane, credit card information pane etc.) that may have drop down form(s) that the follower may activate (e.g., by selection) and fill information (e.g., shipping information, credit card information, etc.).

In another embodiment, the offering display module 218 may mask the identification (e.g., universal resource locator) of the service provider module 102 such that the entity associated with the service provider module 102 is not visible to the follower 106 engaged in the transaction. The offering display module 218 may also remember settings (e.g., personal information, credit card information, etc.) to allow the follower 106 to execute a transaction without entering any information (e.g., by just clicking the ‘buy’ button).

In yet another embodiment, the offering display module 218 may rotate the branded offering along with other branded offerings on the mark-up language page of the admired party module 104 (e.g., based on predefined settings, based on the admired party's preferences, based on a customization of the virtual inventory, based on a temporal marker, etc.). The offering display module 218 may also optimize the mark-up language page of the admired party module 104 for a single offering (e.g., a single sku personalized based on the content and/or the interests of the admired party associated to the mark-up language page) to allow the follower 106 to instantly purchase the single offering (e.g., based on an impulse-buy of the follower) through a single click purchase mechanism (e.g., by using the iframe technology). The display of the offering (e.g., the single sku) may also be optimized so as to preserve subtleness of the mark-up language page (e.g., maintain identity of a web page) so that the follower 106 and/or the admired party module 104 may not find the offerings and/or the mark-up language page obtrusive (e.g., a shopping website).

The order processing module 220 may communicate with the admired party module 104, the follower device 112 and/or distributors 108 to process (e.g., capture, record, track, communicate, etc.) an order (e.g., a selection of branded offerings, a virtual shopping cart, etc. to be purchased by the follower 106 through the commerce engine 114 of the admired party module 104). For example, the order processing module 220 may communicate with the distributor 108 associated with the branded offerings selected by the follower 106 to synchronize a drop-shipping of the offerings to the follower 106 by the distributor 108. The entire fulfillment process may be fully integrated within the branded commerce engine and may not require external shopping applications (e.g., shopping carts, 3rd party catalogues, etc) and/or web service interface (e.g., 3rd party application programming interface).

The transaction module 222 may process (e.g., capture, track, record, communicate, store, monitor, analyze, etc.) financial data and/or meta data associated with the transaction initiated by the follower 106 through the commerce engine 114 of the admired party module 104. The transaction module 222 may process financial preferences and/or information associated with the follower 106 who purchases the offering(s) through the commerce engine 114 to monetize the promotion of the branded offering through the admired party module 104.

For example, the price (e.g., of the offering, and/or to the follower 106) associated with the monetizing of the offering is at a premium (e.g., is higher) to a market price of a comparable offering through a goodwill relationship formed between the follower and the admired party over a series of communications of the admired party made accessible to the follower through a web log structure (e.g., the follower 106 may be a fan of the admired party's blog).

In another embodiment, the price may be at a premium to a market value of the offering based on an empathy relationship between the follower 106 and the admired party formed through the charismatic influence of the admired party on the follower 106, and/or based on an empathy relationship between the follower 106 and the value(s) of the admired party (e.g., the value(s) may be known and/or perceived by the follower 106).

The profit sharing module 224 may process (e.g., determine, calculate, etc.) shares (e.g., splits, distributions, allotments, etc.) of a profit (e.g., derived from a revenue) generated through the purchase of the offering by the follower 106 (e.g., the payment processed of the follower 106 may be communicated by the commerce engine 114 of the admired party module 104 to the service provider module 102).

In one embodiment, the profit sharing module 224 may provide a portion of the profit to the admired party associated with the admired party module 104. The profit sharing module 224 may determine (e.g., analyze, calculate, compute, etc.) the portion of the profit using the profit analyzer 226. For example, the profit sharing module 224 may provide a transparent financial visibility to the admired party of a wholesale purchase of the branded offering (e.g., by the service provider module 102, based on information submitted in the enrollment form 208 by the admired party, and/or from the distributor 108 illustrated in FIG. 1) to the retail sale of the branded offering (e.g., through the commerce engine 114) to any number of followers 106. The profit sharing module 224 may share a significant portion of the margin (e.g., ranging from 10%-35% of downloadable music margin, 50% on books and/or electronic media, 70% on apparels, etc.) with the admired party associated with the admired party module 104.

The reporting module 228 may notify the admired party of the portion of data and/or meta data associated with the portion of the profit payable to the admired party (e.g., the portion of the profit derived from the transaction initiated by the follower 106 through the commerce engine 114 of the mark language page of the admired party module 104).

The accounting module 230 may process (e.g., capture, store, track, records, monitor, analyze, etc.) data and/or meta data associated with wholesale (e.g., base, volume-based, etc.) prices of branded offerings (e.g., quoted by distributors 108 of the branded offerings), retail prices (e.g., of branded offerings on the mark-up language page of the admired party module 104 (e.g., at a premium of the wholesale price), revenue amounts and/or profit distributions to various parties (e.g., to the admired party module 104, the distributor 108, the partner 110 and/or the service provider module 102). The reporting module 228 and/or the accounting module 230 may provide the admired party with real time user statistics (e.g., number of transactions) and/or revenue accounting information (e.g., break-up of revenue) associated to an offering.

In one embodiment, the accounting module 230 may communicate with the commerce engine 114 of the admired party module 104 to process information associated with the virtual inventory of branded offerings (e.g., data and/or meta data associated with a user traffic, an interest, a market, a record and/or log of activity, a sales history, etc.).

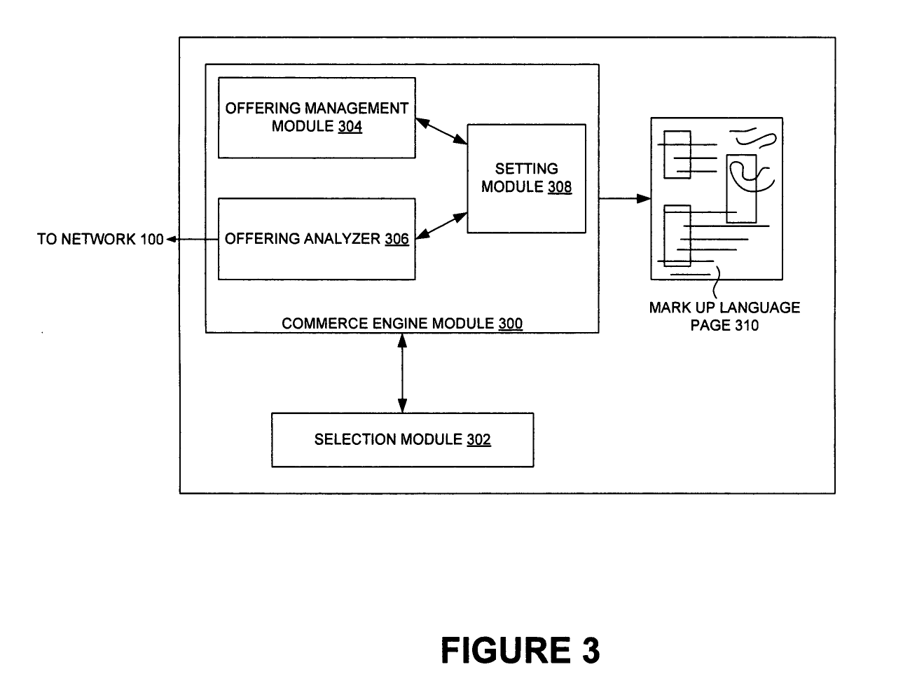

FIG. 3 is an exploded view of an admired party module 104 of FIG. 1, having a commerce engine module 300 and a mark-up language page 310, according to one embodiment. The commerce engine module 300 may include a management module 304, an offering analyzer 306 and/or a setting module 308. The management module 304 may provide the admired party (e.g., associated with the admired party module 104) with an access to control (e.g., an ability to modify) the offering, the virtual inventory and/or aspects of the commerce engine 114 (e.g., illustrated in FIG. 1) of the mark-up language page 310 (e.g., a website, a blog site) generated by the admired party module 104, based on preferences of the admired party.

For example, the management module 304 may automatically populate the mark-up language page 310 (e.g., the website) of the admired party with at least one offering (e.g., the branded offering) representing a value of the admired party (e.g., a political value, a social value, a religious value, a personal value, etc.) when the admired party integrates the branded commerce engine (e.g., the commerce engine 114) in the mark-up language page 310. The admired party may also be able to customize the description of an offering (e.g., through simple text, thumbnail, etc.).

The offering analyzer 306 may process (e.g., compare, analyze, track, etc.) the virtual inventory of the commerce engine 114 (e.g., illustrated in FIG. 1) with data and/or meta data communicated by the setting module 308. For example, the offering analyzer 306 may communicate with the service provider module 102 to determine whether the virtual inventory (e.g., having branded offerings generated based on preferences of the admired party) matches the preferences (e.g., statically, temporally, periodically and/or dynamically) communicated by the admired party (e.g., through the enrollment module 200 of FIG. 2, the setting module 308 and/or the management module 304).

The setting module 308 may process (e.g., capture, track, store, analyze, record and/or monitor) settings associated with the preferences of the admired party (e.g., associated with the settings for the offerings of the virtual inventory and/or the commerce engine 114 of the mark-up language page 310). For example, the admired party may modify preferences and/or values he/she communicated with the enrollment module 200 of FIG. 2, and or may wish the commerce engine 114 to recognize consistent, predicted and/or a base set of future preferences, rules and/or values (e.g., associated with the admired party) through the setting module 308 of the commerce engine module 300. In one embodiment, a communication by the admired party through the setting module 308 may update the profile database 210 of FIG. 2.

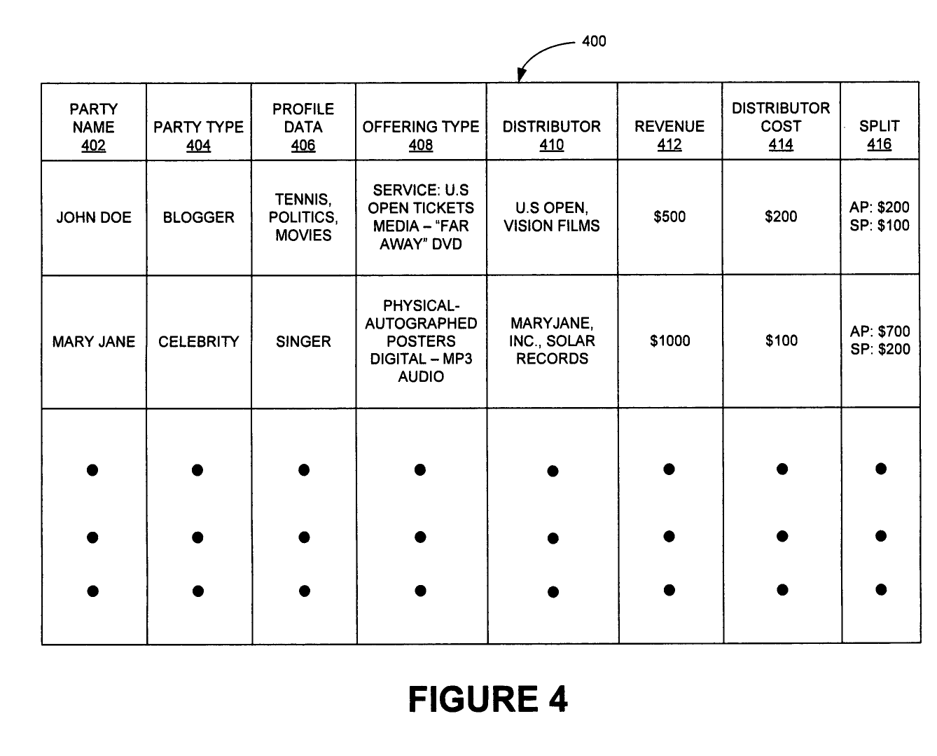

FIG. 4 is a table view 400 of content referenced by the profile database 210 of FIG. 2, having a party name field 402, a party type field 404, a profile data field 406, an offering type field 408, a distributor field 410, a revenue field 412, a distributor cost field 414, and a split field 416, according to one embodiment. The party name field may display an identifier associated with the admired party (e.g., having an admired party module 104).

The party type field 404 may display a label indicating a nature of a charisma of the admired party that may be perceptible to a follower 106 in a context (e.g., a social context, a web presence context, a political context, etc.). The profile data field 406 may display identifiers referencing values (e.g., interests, causes, beliefs, hobbies, etc.) of the admired party. The offering type field 408 may display labels indicating the nature of the offerings (e.g., digital, physical, service) provided by the commerce engine 114 of FIG. 1 on the mark-up language page generated by the admired party module 104.

The distributor field 410 may display an identifier referencing the distributor (e.g., the distributor 108 illustrated in FIG. 1. The revenue field 412 may display a revenue (e.g., of the service provider module 102) generated by (e.g., derived from) the purchase of the offering by the follower 106 through the commerce engine 114 integrated into the mark-up language page of the admired party module 104.

The distributor cost field 414 may display a value associated with the wholesale price of the offering (e.g., the distributor's price and/or cost of services rendered to the service provider module 102 for the branded offer). The split field may display a distribution of a profit (e.g., the revenue referenced in the revenue field 412 less the distributor cost referenced in the distributor cost field 414) between the service provider module 102 and the admired party module 104.

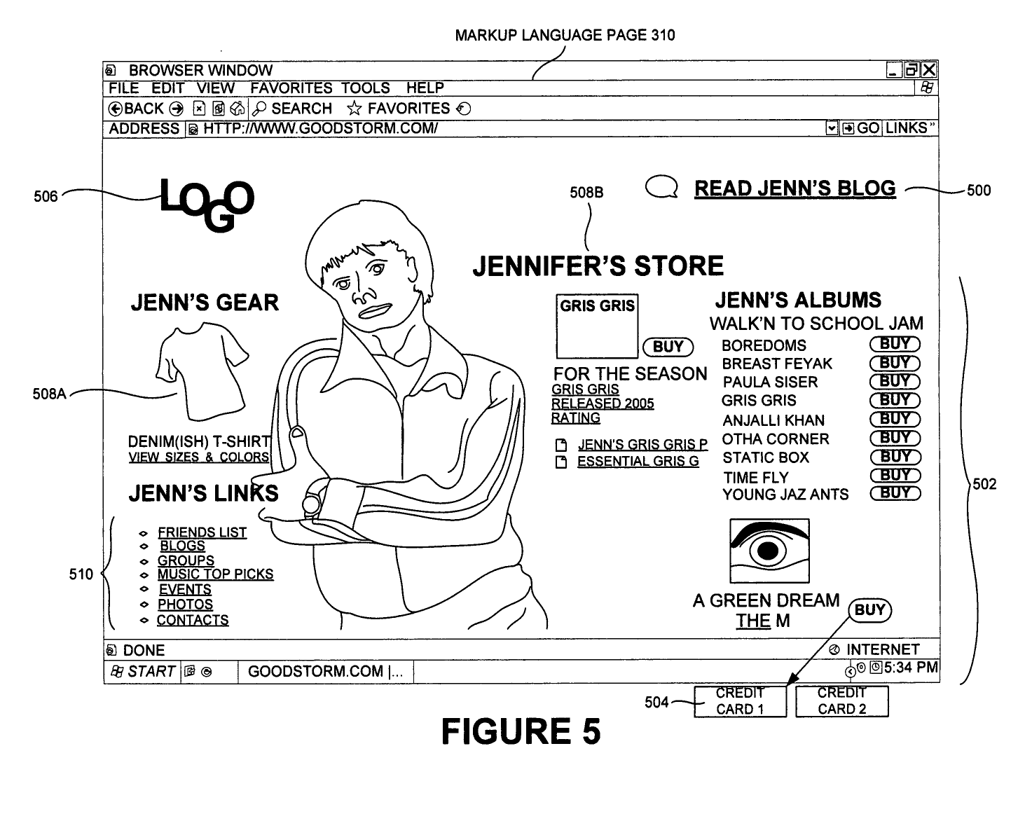

For example, two hypothetical admired parties of the profile database 210 are illustrated in FIG. 5. The party name field 402 displays “John Doe” and Mary Jane,” indicating the name of the admired parties. The party type field indicates “Blogger” and “Celebrity,” indicating that John Doe may have a charisma amongst followers 106 who may be readers of his blog, and that Mary Jane may have a social charisma amongst followers 106 based on her status as a celebrity.

The profile data field 406 displays “Tennis, Politics, Movies” and “Singer,” indicating that John may have values and/or interests including tennis, politics and/or movies, while Mary may be a celebrity singer. The offering type field 408 displays “service—U.S. Open tickets, Digital Media—Far Away DVDs” and “Physical—Autographed Posters, Digital—mp3 Audio,” indicating that John's virtual inventory of branded offerings (e.g., provided on John's blog through the commerce engine 114 illustrated in FIG. 1) includes services such as tickets to a prominent tennis tournament and/or media such as digital video discs of a motion picture (e.g., movie), and that Mary Jane's virtual inventory of branded offerings (e.g., provided on Mary Jane's website) includes physical offerings such as autographed posters of Mary Jane and/or digital media such as audio recordings of her music (e.g., in an mp3 format).

The distributor field 410 displays “U.S. Open, Vision Films” and “MaryJane, Inc., Solar Records,” indicating that the distributor associated with drop-shipping the offerings promoted on John's virtual inventory to followers 106 who purchase the offerings on John's blog site is “U.S. Open” for the tennis tournament tickets and “Vision Films” for the DVD movies, while the distributors associated with Mary Jane's virtual inventory are “MaryJane, Inc.” for the autographed posters and “Solar Records” for the audio recordings of her music.

The revenue field 412 displays “$500” and “$1000,” indicating that followers 106 of John's blog site have purchased $500 (e.g., have submitted a total of $500 in payment) of John's branded offerings, while followers 106 of Mary Jane's website have purchased $1000 of her branded offerings. The distributor cost field 414 displays “200” and “100,” indicating that the wholesale price (e.g., the price charged by the distributors 108 for providing and shipping the branded offerings ordered by the followers 106) for John's sales (e.g., the offerings purchased by followers 106 through the integrated branded commerce engine on John's blog site) is $100, while the wholesale price (e.g., the cost to the service provider module of the services rendered by the distributor 108) for Mary Jane's offerings is $100.

The split field 416 displays “AP: $200, SP: $100” and “AP: $700, SP: $200,” indicating that in the case of John, the portion of the profit ( e.g., the revenue less the distributor cost) from the transactions (e.g., from the payments processed of the followers 106 who purchased offerings through the admired party module 104 associated with John) that goes to John (e.g., the admired party, using the service provider module 102) is $200, while $100 goes to the service provider module 102. In the case of Mary Jane, the portion of the profit from the transactions through Mary Jane's website that goes to Mary (e.g., the admired party) is $700, while $200 goes to the service provider module 102.

FIG. 5 is a user interface view of the mark-up language page 310 of FIG. 3 associated with the admired party module 104 of FIG. 1, having a prompt view 500, a commerce engine view 502, an embedded payment processing view 504, a logo view 506, virtual inventory views 508A and 508B, and a links view 510, according to one embodiment.

The prompt view 500 may display a message customized to the admired party (e.g., “Jennifer,” based on information provided by Jennifer in a communication with the enrollment module 200 of FIG. 2). The prompt view 500 may alert the viewer (e.g., the follower 106) of the admired party (e.g., “Jennifer”) of other content associated with Jennifer (e.g., a blog site of Jennifer's). The commerce engine view 502 may display content associated with functions of the commerce engine 114 illustrated in FIG. 1 (e.g., may provide options for the follower 106 to view, compare, search, order and/or purchase, etc. branded offerings promoted by Jennifer).

The embedded payment processing view 504 is an example illustration of a function of the commerce engine (e.g., may not be visible to a viewer such as the follower 106). The commerce engine 114 illustrated in the commerce engine view 502 may reference an external payment verification authority (e.g., any number of credit card companies) to process and/or finalize a purchase transaction made by the follower 106 on Jennifer's mark-up language page (e.g., the mark-up language page 310).

The logo view 506 may display a textual and/or graphic visualization (e.g., may be designed by the admired party to be in alignment with a value of the admired party). The virtual inventory views 508A and 508B display a menu of branded offerings being promoted by the admired party (e.g., “Jennifer”). The virtual inventory may include selections, options to search the inventory, preferences, etc.

The service provider module 102 and Jennifer (e.g., the admired party associated with the user interface view illustrated in FIG. 5) may not physically stock any of the offerings promoted in the virtual inventory views (e.g., the offerings and/or items may be drop-shipped by a distributor 108 to the purchaser such as the follower 106 based on a the follower 106 completing an order through the commerce engine view 502).

The links view 510 may notify the viewer of other mark-up language pages that may be of interest to the viewer (e.g., the follower 106). For example, the other mark-up language pages may be associated with admired parties who are known to Jennifer (e.g., based on the follower 106 having an empathy and/or affinity for Jennifer based on a charismatic influence of hers). The follower 106 may be likely to want to visit websites and/or blogs (e.g., the mark-up language page 310) associated with admired parties who are known to Jennifer.

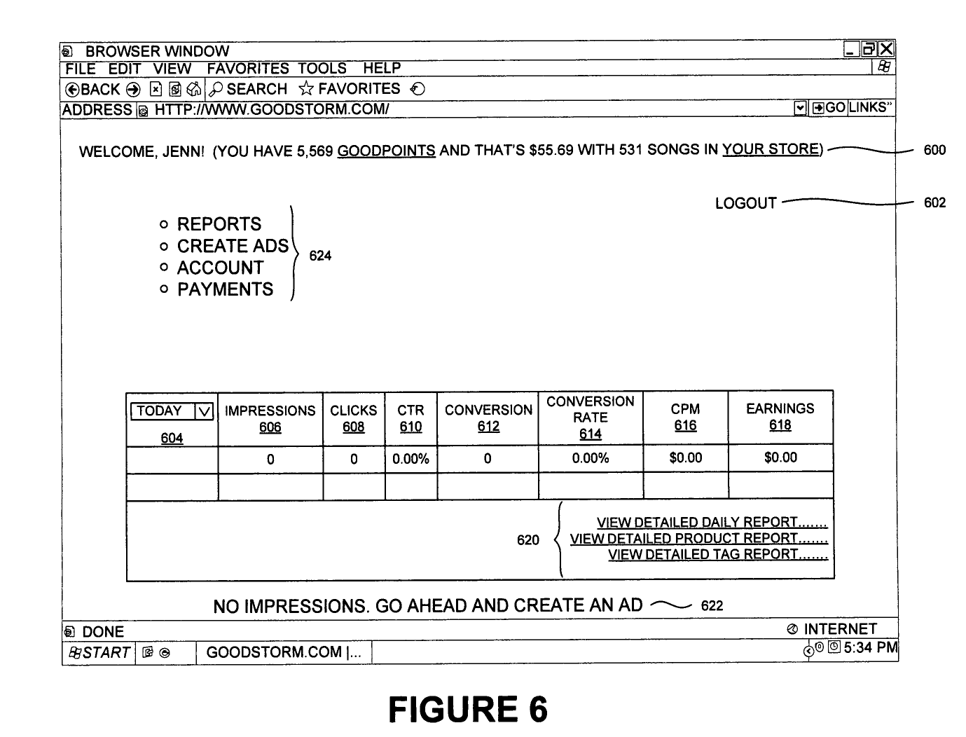

FIG. 6 is a user interface view of the service provider module of FIG. 1, having a welcome view 600, a logout view 602, a today view 604, an impressions view 606, a clicks view 608, a CTR (e.g., click-through rate) view 610, a conversion view 612, a conversion rate view 614, a CPM (e.g., cost per thousand impressions) view 616, an earnings view 618, a report view 620, a create ad view 622, and an options view 624, according to one embodiment.

The welcome view 600 may display a welcome message (e.g., to the admired party associated with the service provider module 102) based on information provided by the admired party (e.g., through a communication with the enrollment module 200 and/or the profile database 210 of FIG. 2). The welcome view may also include indicators of Jennifer's offerings, virtual inventory and/or account value (e.g., may display a point-based index value of the offerings in Jennifer's virtual inventory and/or account with the service provider module based on a communication with the profile database 210).

The logout view 602 may provide the admired party an option to exit the user interface view. The today view 604 may display data, meta data and/or statistical information associated with the date (e.g., the day, the calendar date) on which the admired party accesses the user interface view. For example, the today view 604 may notify the admired party of significant events (e.g., associated with the mark-up language page 310, the commerce engine 114 and/or the virtual inventory associated with the admired party) that occurred on the same day.

The impressions view 606 may display a value indicating a number of times an impression (e.g., a banner display, a pop-in, a link, etc.) is displayed of the offering in the admired party's virtual inventory (e.g., generated based on actions of the viewers). The clicks view 608 may display a value indicating a number of times viewers (e.g., the followers 106 of the admired party) may have clicked (e.g., with a mouse, with a touchpad, with a keyboard key, with a trackball, etc.) on various items (e.g., associated with the offerings) displayed on the mark-up language page 310 of the admired party (e.g., associated with the admired party module 104).

The CTR (e.g., click-through rate) view 610 may display a value indicating a ratio (e.g., a percentage, a metric, a decimal number, etc.) of the number of times the impression is displayed to the number of times the viewer clicks on the display (e.g., clicks through). The conversion rate view 614 may indicate a value expressing a number of conversions (e.g., successful transactions, requests for further information, etc.) relative to (e.g., as a fraction of) the number of viewers (e.g., the followers 106) that have visited the mark-up language page 310 (e.g., website) associated with the admired party.

The CPM (e.g., cost per thousand) view 616 may indicate a value for the cost (e.g., to the admired party, associated with the display of the impression for the offering) per every thousand impressions (e.g., displays of the offering generated by the viewers of the admired party's mark-up language page). The earnings view 618 may indicate a currency value of the total conversions (e.g., completed transactions, purchases, etc.) generated within a time frame. The report view 620 may provide the admired party with options (e.g., for visualizing, summarizing, expressing, recording, exporting and/or interpreting, etc.) the data, meta data and/or statistical information displayed and/or not displayed elsewhere in the user interface view.

The content displayed in the create ad view 622 may depend on certain value thresholds of the number of impressions indicated in the impressions view 606 (e.g., may prompt the admired party to create an advertisement and/or marketing effort to improve the number of impressions generated by viewers of the mark-up language page of the admired party (e.g., followers 106 of the admired party). The options view 624 may provide the admired party with options (e.g., choices) to access, extract, refer to, generate and/or reference, etc. various data, information, and/or meta data (e.g., the admired party's preferences, profile settings, reports for activity on the mark-up language page 310 of the admired party, financial options for the admired party, options for the admired party to modify content on the mark-up language page 310, settings for the commerce engine of the mark-up language page 310 associated with the admired party, etc.).

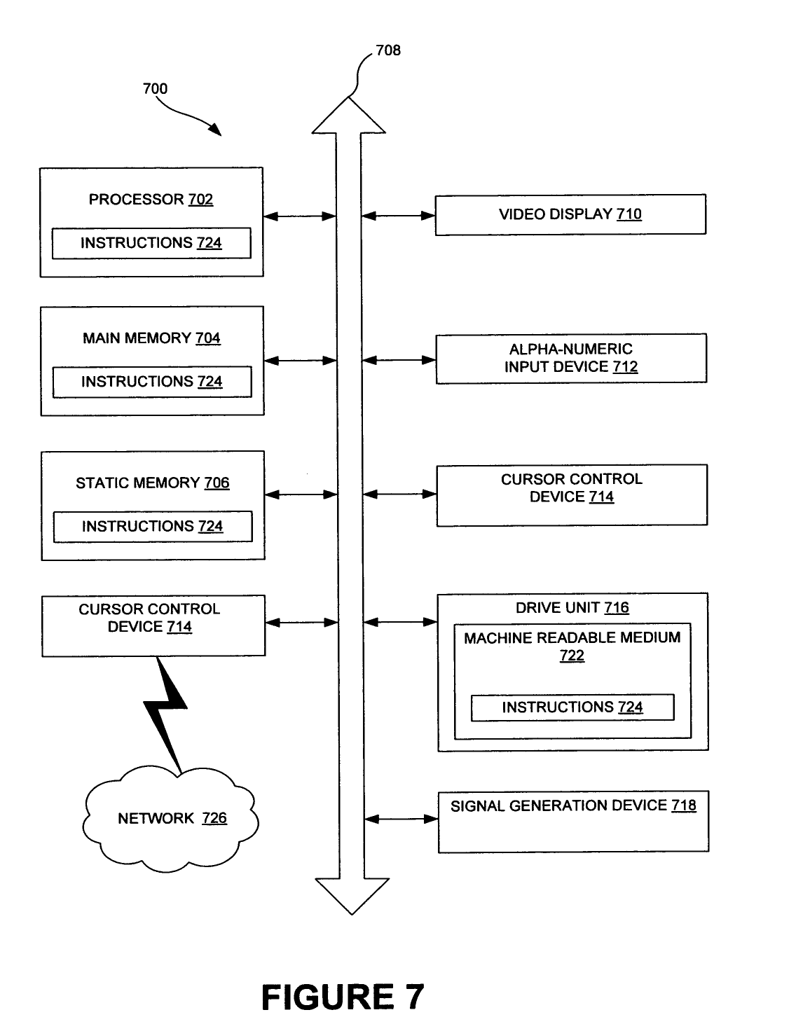

FIG. 7 is a diagrammatic representation of a computer system 700 capable of processing a set of instructions to perform any one or more of the methodologies herein, according to one embodiment. In various embodiments, the machine operates as a standalone device and/or may be connected (e.g., networked) to other machines. In a networked deployment, the machine may operate in the capacity of a server and/or a client machine in server-client network environment, and/or as a peer machine in a peer-to-peer (or distributed) network environment.

The machine may be a personal computer (PC), a tablet PC, a set-top box (STB), a Personal Digital Assistant (PDA), a cellular telephone, a web appliance, a network router, switch and/or bridge, an embedded system and/or any machine capable of executing a set of instructions (sequential and/or otherwise) that specify actions to be taken by that machine. Further, while only a single machine is illustrated, the term “machine” shall also be taken to include any collection of machines that individually and/or jointly execute a set (or multiple sets) of instructions to perform any one and/or more of the methodologies discussed herein.

The example computer system 700 includes a processor 702 (e.g., a central processing unit (CPU) a graphics processing unit (GPU) and/or both), a main memory 704 and a static memory 706, which communicate with each other via a bus 708. The computer system 700 may further include a video display unit 710 (e.g., a liquid crystal display (LCD) and/or a cathode ray tube (CRT)). The computer system 700 also includes an alphanumeric input device 712 (e.g., a keyboard), a cursor control device 714 (e.g., a mouse), a disk drive unit 716, a signal generation device 718 (e.g., a speaker) and a network interface device 720.

The disk drive unit 716 includes a machine-readable medium 722 on which is stored one or more sets of instructions (e.g., software 724) embodying any one or more of the methodologies and/or functions described herein. The software 724 may also reside, completely and/or at least partially, within the main memory 704 and/or within the processor 702 during execution thereof by the computer system 700, the main memory 704 and the processor 702 also constituting machine-readable media.

The software 724 may further be transmitted and/or received over a network 726 via the network interface device 720. While the machine-readable medium 722 is shown in an example embodiment to be a single medium, the term “machine-readable medium” should be taken to include a single medium and/or multiple media (e.g., a centralized and/or distributed database, and/or associated caches and servers) that store the one or more sets of instructions. The term “machine-readable medium” shall also be taken to include any medium that is capable of storing, encoding and/or carrying a set of instructions for execution by the machine and that cause the machine to perform any one or more of the methodologies of the various embodiments. The term “machine-readable medium” shall accordingly be taken to include, but not be limited to, solid-state memories, optical and magnetic media, and carrier wave signals.

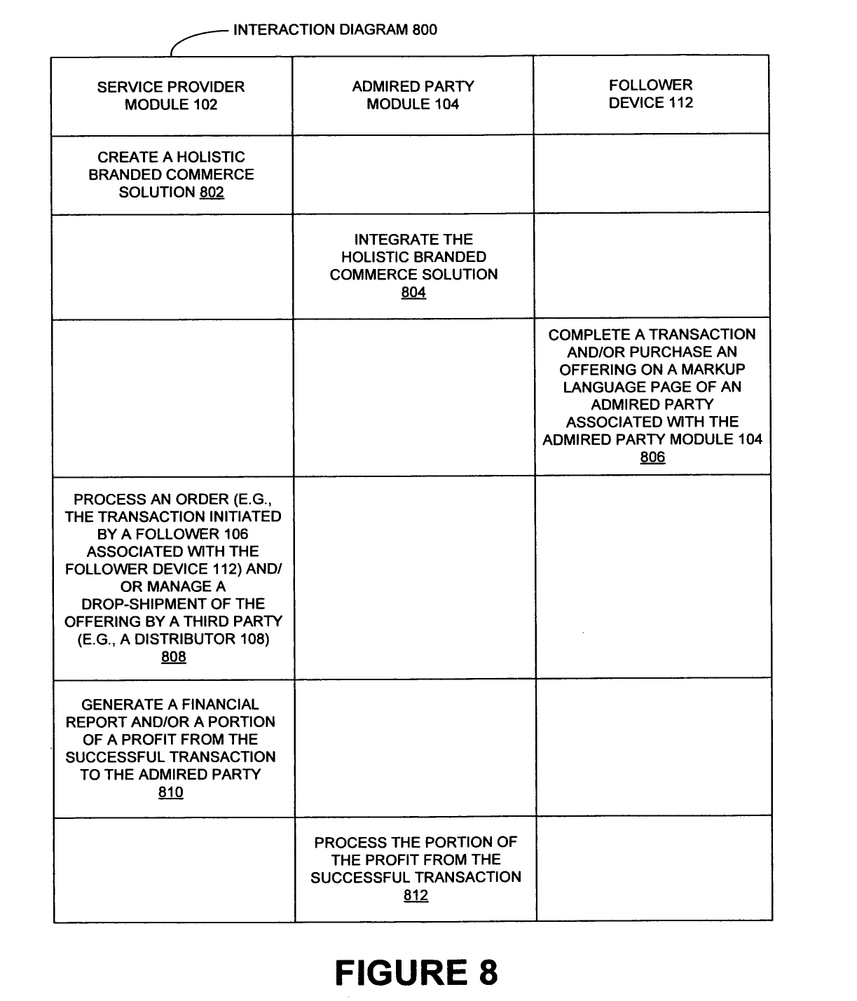

FIG. 8 is an interaction diagram of a process flow between the service provider module 102, the admired party module 104 and the follower device 112 of FIG. 1, according to one embodiment. In operation 802, the service provider module 102 creates a holistic branded commerce solution (e.g., for an admired party to monetize a charismatic influence an/or empathetic influence etc. Over a follower such as the follower 106 illustrated in FIG. 1 through a mark-up language page (e.g., website, blog, etc.). In operation 804, the admired party module 104 integrates (e.g., embeds) the holistic branded commerce solution (e.g., the commerce engine 114 of FIG. 1) into the mark-up language page (e.g., the mark-up language page 310 illustrated in FIG. 3) of the admired party. In operation 806, the follower device 112 (e.g., associated with the follower 106) completes (e.g., initiates and completes) a transaction and/or purchases an offering (e.g., an offering of a virtual inventory) on a mark-up language page (e.g., the mark-up language page 310) of an admired party associated with the admired party module 104.

For example, the follower 106 may purchase the offering a price premium to a market price of a comparable offering, based on an empathy with a value of the admired party (e.g., a personal value, a political value, a religious value, a controversial value, etc.). In operation 808, the service provider module 102 processes an order (e.g., the transaction initiated by the follower 106 associated with the follower device 112), and/or manages (e.g., facilitates) a drop-shipment of the offering by a third party (e.g., a distributor 108). For example, the service provider module 102 and the admired party module 104 may not hold a physical inventory of the offerings on the mark-up language page 310. In operation 810, the service provider module 102 generates a financial report (e.g., using the reporting module 228 of FIG. 2) and/or a portion of a profit from the successful transaction (e.g., determined using the profit analyzer 226 and/or the profit sharing module 224 of FIG. 2) to the admired party. In operation 1012, the admired party module 104 (e.g., associated with the admired party of the mark-up language page 310) processes (e.g., receives) the portion of the profit from the successful transaction.

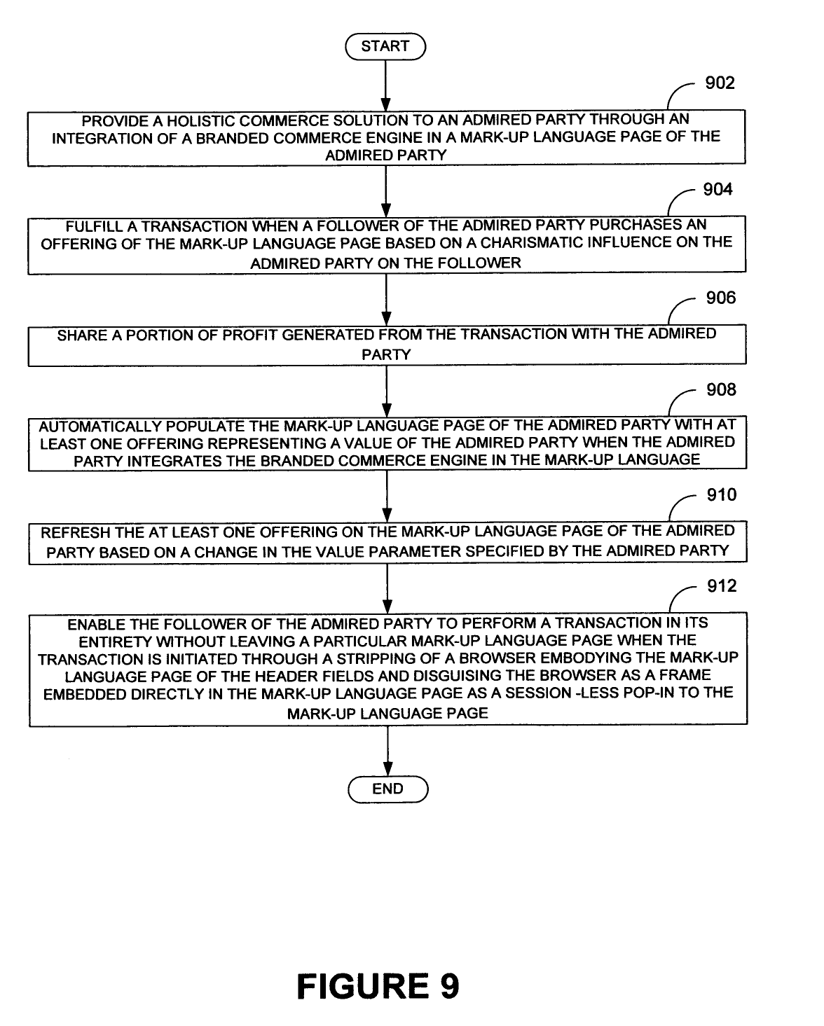

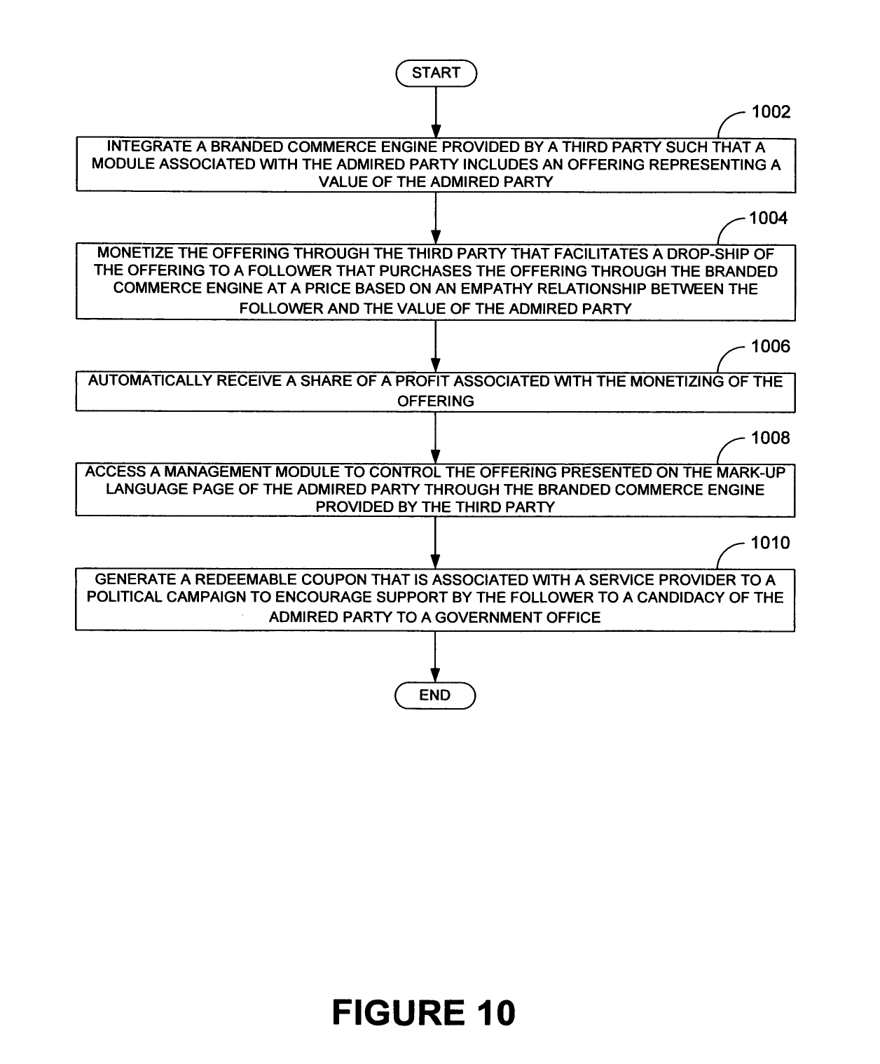

FIG. 9 is a process flow to provide a holistic commerce solution to an admired party, according to one embodiment. In operation 900, a holistic commerce solution is provided (e.g., by the service provider module 102 of FIG. 10 to an admired party (e.g., a celebrity, a blogger, a party having a social presence, a charismatic presence, a web presence, etc.) through an integration of a branded commerce engine (e.g., the commerce engine 114 illustrated in FIG. 1) in a mark-up language page (e.g., a website, a blog, the mark-up language page 310 illustrated in FIG. 3, etc.) of the admired party.

In operation 902, a transaction is fulfilled when a follower (e.g., the follower 106 illustrated in FIG. 1, having an empathy for, and/or appreciation for the admired party and/or values of the admired party) of the admired party purchases an offering (e.g., a digital media offering, a physical offering, a service etc.) on the mark-up language page 310 (e.g., from a virtual inventory provided on the mark-up language page 310) based on a charismatic influence of the admired party on the follower 106. In operation 904, a portion of a profit generated from the transaction is shared with the admired party (e.g., using the profit sharing module 224 of FIG. 2).

In operation 906, the mark-up language page 310 of the admired party is automatically populated with an offering representing a value of the admired party (e.g., may be determined through the enrollment module 200 and/or the profile database 210) when the admired party integrates the branded commerce engine in the mark-up language page 310. In operation 908, the offering on the mark-up language page 310 of the admired party is refreshed based on a change in the value parameter specified by the admired party (e.g., using the management module 304 of the commerce engine module 300 illustrated in FIG. 3).

In operation 910, the follower of the admired party (e.g., associated with the admired party module 104) is enabled to perform a transaction in its entirety without leaving a particular mark-up language page 310 when the transaction is initiated (e.g., using an i-frame technique, through a stripping of a browser embodying the mark-up language page of header fields and/or disguising the browser as a frame embedded directly in the mark-up language page as a session-less pop-in to the mark-up language page, etc.).

FIG. 10 is a process flow to integrate a branded commerce engine (e.g., the commerce engine 114 illustrated in FIG. 1) provided by a third party, according to one embodiment. In operation 1000, a branded commerce engine provided by a third party (e.g., the service provider module 102 illustrated in FIG. 1) is integrated such that a module associated with the admired party (e.g., the admired party module 104 illustrated in FIG. 1) includes an offering representing a value of the admired party (e.g., a political value, a religious value, a social value, a controversial value, a personal value etc.)

In operation 1002, the offering is monetized through the third party that facilitates a drop-ship of the offering (e.g., the distributor 108 illustrated in FIG. 1) to a follower (e.g., the follower 106 of FIG. 1) that purchases the offering through the branded commerce engine (e.g., the commerce engine 114) at a price based on an empathy relationship between the follower 106 and the value of the admired party (e.g., the price may be at a premium to a market value of the offering).

In operation 1004, a share of a profit associated with the monetizing of the offering is automatically received (e.g., by the service provider module 102 and/or the admired party module 104) in operation 1006, a management module (e.g., the management module 304 of FIG. 3) is accessed to control the offering presented on the mark-up language page 310 of the admired party through the branded commerce engine provided by the third party (e.g., the service provider module 102). In operation 1008, a redeemable coupon is generated that is associated with a service provider (e.g., of the service provider module 102) to a political campaign to encourage support by the follower 106 to a candidacy of the admired party to a government office.

FIG. 11 is a system view of a network 1100 of a distributor module 1102 and a publisher module 1104, according to one embodiment. Particularly, in FIG. 11 illustrates the distributor module 1102, the publisher module 1104, a patron device 1106, a patron 1108, a vendor module 1110, a media module 1112, a merchandise module 1114, a delivery module 1116, a criterion module 1118, a profile module 1120, a page view 1122, an electronic message module 1124, a content data 1126, a custom media playlist 1128, a customizable merchandise item 1130, and a commerce engine 1132.

The distributor module 1102 may be a software program and/or a hardware circuitry which provides a number of services (e.g., the custom media playlist 1128, the customizable merchandise item1124, and/or the electronic message 1500 of FIG. 15) through the publisher module 1104. The publisher module 1104 may be a website (e.g., personal) that may have the custom media playlist 1128 and/or the customizable merchandise item 1130 adjacent to the content data 1126. The patron device may be a machine and/or a computer that may interact with the patron 1108 to access the publisher module 1104.

The patron 1108 may be a person who subscribes to the content data 1126 of the publisher module 1104. The vendor module 1110 may be a communication device which allows each member of vendors (e.g., who may supply an inventory of goods requested by the patron 1108 through the publisher module 1104 and/or the distributor module 1102) to process an order from the patron 1108 routed through the distributor module 1102 and/or to access a transaction data of the order which may be provided from the distributor module 1102.

The media module 1112 may be a software program and/or a hardware circuitry which may generate a virtual store of a media playlist on a page (e.g., the page view 1122) of the publisher module 1104. An initial page view of the virtual store (e.g., having a jukebox, a multiplex, etc.) may be generated based on the criterion module 1118. The merchandise module 1114 may be a software program and/or a hardware circuitry which may generate a virtual store of a customizable merchandise item on a page (e.g., the page view 1122) of the publisher module 1104. An initial page view of the virtual store (e.g., which enables the patron 108 to design a t-shirt, a mug, etc.) may be generated based on a criterion of the publisher module 1104.

The delivery module 1116 may be a software program and/or a hardware circuitry which may communicate an electronic message (e.g., an electronic message 1500 of FIG. 15) to the patron device 1106. The criterion module 1118 may be an algorithm (e.g., arithmetic and/or logic) used to select a collection of media files (e.g., music files, movie files, etc.) populating the custom media playlist 1128 based on a criterion data of the patron 1108. The profile module 1120 may be an algorithm (e.g., arithmetic and/or logic) used to pick a representative of a customizable offering (e.g., a t-shirt, a mug, etc.) occupying the customizable merchandise item 1130 based on a profile data of the publisher module 1104.

The page view 1122 may be a user interface view of the content data 1126, the custom media playlist 1128, and/or the customizable merchandise item 1130. The electronic message module 1124 may be a software program and/or a hardware circuitry which conveys a command data to communicate an electronic message 1500 of FIG. 15 having the commerce engine 1132 to the delivery module 1116 and/or applies (e.g., embeds) the commerce engine 1132 associated with any one virtual store (e.g., of a jukebox, a multiplex, a t-shirt, and/or a mug) to a message portion of the electronic message 1500 prior to a conveyance of the electronic message using the delivery module 1116.

The content data 1126 may be a data (e.g., a text data, a picture data, a media data, etc.) conveying a personal view (e.g., of social, political, mundane, etc.) of a host (e.g., a blogger, a diarist, etc.) of the website (e.g., a blog, an online diary, etc.). The custom media playlist 1128 may be a representative a collection of media files (e.g., music files, movie files, etc) offered to the patron 1108. The customizable merchandise item 1130 may be an item being sold through a virtual store (e.g., selling a customizable t-shirt and/or a mug) of the publisher module 1104. The commerce engine 1132 may be a program script, a code, a plug-in, and/or a utility of an offering being offered in the custom media playlist 1128 and/or the customizable merchandise item 1130.

For example, as illustrated in FIG. 11, the patron device 1106 may interact with the distributor module 1102 to customize and/or procure an offering and/or offerings through the custom media playlist 1128 and/or the customizable merchandise item 1130 of the publisher module 1104. The publisher module 1104 may communicate a user interface view of the publisher module 1104 to the patron device 1106. In addition, the publisher module 1104 may communicate with the distributor module 1102 to provide a fully-embedded view of the custom media playlist 1128 and/or the customizable merchandise item 1130 of the publisher module 1104. The vendor module 1110 may communicate with the distributor module 1102 through the network 1100 to supply a number of goods (e.g., tangible and/or intangible) to the patron 1108.

Furthermore, a custom media playlist (e.g., the custom media playlist 1128) may be generated on a space adjacent to a content data (e.g. the content data 1126) associated with a criterion (e.g., which may be obtained through a registration process of the patron 1108 to sign up for a website of the publisher module 1104 and/or which may be based on a past transaction history of the patron 1108) of a patron (e.g., the patron 1108) of a publisher module (e.g., the publisher module 1104) having the content data (e.g., the content data 1126).

Also, a transaction of a particular item of the custom media playlist may be enabled without leaving the space adjacent to the content data. A frequency of instances of the transaction may be spurred (e.g., stimulated, increased, etc.) when at least one of the transaction of the particular item is associated with a charismatic influence (e.g., which may be based on an empathy relationship between the patron 1108 and the value(s) of the publisher module 1104 where the value(s) may be based on one or more of social, political, and other views) of the publisher module 1104 (e.g., where a profit of the transaction may be shared between the publisher module 1104 and the distributor module 1102).

A representation of a customizable merchandise item 1130 may be generated on a location adjacent to the content data 1126 of the publisher module 1104 based on a profile (e.g., based on a personal value, a political value, a religious value, a professional value, a social value and/or a controversial value, etc.) of the publisher module 1104. A transaction of the customizable merchandise item 1130 may be processed while fully preserving the transaction in the location adjacent to the content data.

The patron 1108 may be able to perform the entire transaction through a single click of a pointing device (e.g., a mouse) through an iframe technology (e.g., by embedding a document within another document) whereby the follower may be able to view and/or provide information (e.g., detailed product specification, buyer information, credit card information, shipping and/or handling information, etc.) in a single browser window embedded in the mark-up language page, without leaving the page view 1122 of the publisher module 1104.

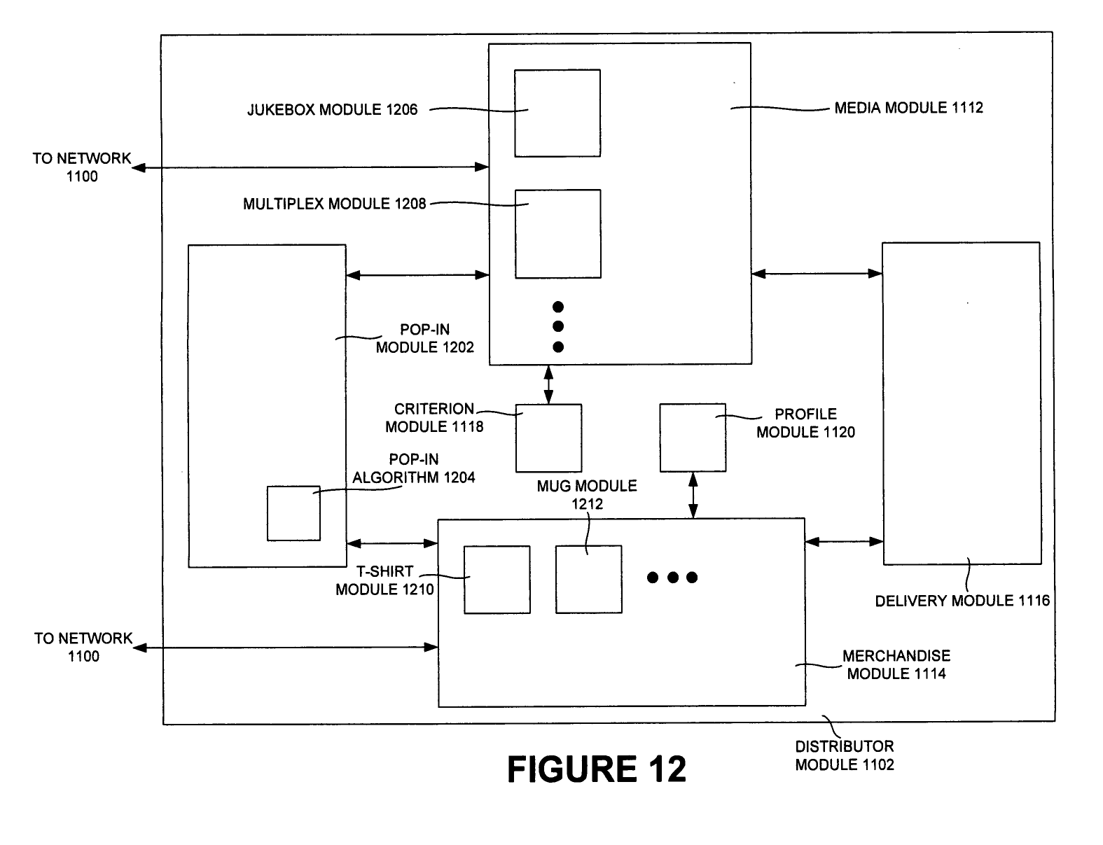

The single browser window may have multiple panes (e.g., shipping information pane, credit card information pane etc.) that may have drop down form(s) that the follower may activate (e.g., by selection) and fill information (e.g., shipping information, credit card information, etc.). An instance of the transaction of the customizable merchandise item 1130 may be promoted when the patron 1108 of the t-shirt module 1210 of FIG. 12 purchases the customizable merchandise item 1130 based on a charismatic influence of the publisher module.

The commerce engine 1132 having a manifestation of an offering may be embedded in a message text 1508 of FIG. 15 of the electronic message 1500. The electronic message 1500 may be communicated to a recipient (e.g., the patron 1108, an acquaintance of the patron 1108, etc.). A profit of a transaction may be shared with a sender (e.g., the host of the publisher module 1104, the patron 1108, etc.) of the electronic message 1500 when the recipient of the electronic message 1500 makes the transaction based on a charismatic influence of the sender (e.g., where an existence of the charismatic influence is predetermined based on an agreement between the sender and the distributor module 1102).

FIG. 12 is an exploded view of the distributor module 1102 of FIG. 11, according to one embodiment. Particularly, in FIG. 11 illustrates a pop-in module 1202, a pop-in algorithm 1204, a jukebox module 1206, a multiplex module 1208, a t-shirt module 1210, and/or a mug module 1212. The pop-in module 1202 may be a software program and/or a hardware circuitry which enables the patron 1108 of FIG. 1 to access the content data 1126, the custom media playlist 1128 and/or the customizable merchandise item 1130 without leaving a network address of the publisher module 1104 (e.g. based on the iframe technology addressed supra). The pop-in algorithm 1204 may be an algorithm (e.g., mathematical and/or logical) which is used to support the pop-in module 1202 using the iframe technology.

The jukebox module 1206 may be a sub-module (i.e., in software and/or hardware) of the media module 1112 which populates the custom media playlist 1128 with a collection of music and/or enables the patron 1108 to access (e.g., through downloading, podcasting, streaming, etc.) the collection of music based on a preference of the patron 1108. The mutiplex module 1208 may be another sub-module of the media module 1112 which populates the custom media playlist 1128 with a collection of movies and/or allows the patron 1108 to access the collection of movies based on the preference of the patron 1108. The t-shirt module 1210 may be a sub-module (i.e., in software and/or hardware) of the merchandise module 1114 which selects a t-shirt item to fill the customizable merchandise item 1130 and/or enables the patron 1108 to stylize the t-shirt based on a taste of the patron 1108. The mug module 1212 may be a sub-module of the merchandise module 1114 which selects a mug to fill the customizable merchandise item 1130 and/or enables the patron 1108 to stylize the mug based on a taste of the patron 1108.

For example, as illustrated in FIG. 12, the pop-in module 1202 interacts with the media module 1112 and the merchandise module 1114 to enable the patron 1108 of FIG. 11 view and/or provide information (e.g., detailed product specification, buyer information, credit card information, shipping and/or handling information, etc.) in a single browser window embedded in the mark-up language page, without leaving the mark-up language page of the publisher module 1104. The delivery module 1116 communicates with the media module 1112 and the merchandise module 1114 to enable a delivery of an offering (e.g., a juke box, a multiplex, a t-shirt, a mug) as an electronic message (e.g., the electronic message 1500 of FIG. 15) to a recipient.

Furthermore, the custom media playlist 1128 may be configured based on a preference data (e.g., a genre data, a topline data, a period data, a popularity data, and/or an other data) of the patron 1108. The customizable merchandise item 1130 may be stylized using a filter (e.g., a filter module 1402 of FIG. 14) based on a choice data (e.g., a type data, a size data, a graphic data, and/or a text data) of the patron 1108 of the publisher module 1104.

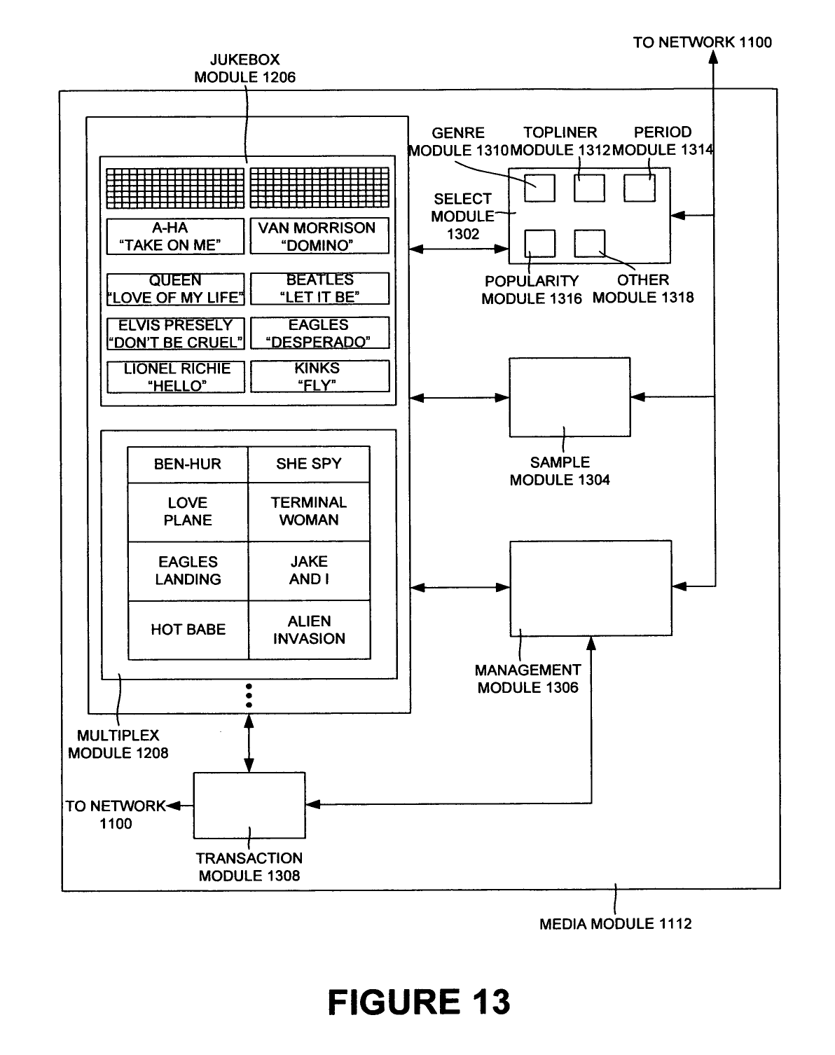

FIG. 13 is an exploded view of the media module 1112 of FIG. 11, according to one embodiment. Particularly, in FIG. 13 illustrates a select module 1302, a sample module 1304, a management module 1306, a transaction module 1308, a genre module 1310, a topliner module 1312, a period module 1314, a popularity module 1316, and/or an other module 1318. The select module 1302 may enable the patron 1108 of FIG. 11 to list a collection songs to be displayed on the jukebox module 1206 of FIG. 12 based on a preference data (e.g., a genre data, a topliner data, a period data, a popularity data, and/or an other data) of the patron 1108.

The sample module 1304 may provide the patron 1108 to preview a media file (e.g., a music, a movie, etc.) the patron 1108 may be purchasing when the media file (e.g., whole and/or in part) may be downloaded (e.g., via streaming) to the patron 1108. The management module 1306 may oversee a transaction taking place in the media module 1112 of FIG. 11 and/or accommodate a request of the patron 1108 using the other module 1318. The transaction module 1308 may allow the patron 1108 to complete a transaction of any item of the custom media playlist 1128 without leaving the page view 1122.

The genre module 1310 may list a number of categories (e.g., a rap, a classic, a disco, etc. for a music and/or a comedy, a drama, etc. for a movie) of media files. The topliner module 1312 may list a name (e.g., of a movie star, a singer, a popular figure, etc.) which may draw the patron 1108 to purchase an offering (e.g., a song, a movie, etc.). The period module 1314 may categorize the offering based on a time of its birth (e.g., 50s music, 70s movie, etc.). The popularity module 1316 may categorize the offering based on a level of the popularity of the offering (e.g., which may be evidenced by an existing standard, such as The Billboard for music, etc.). The other module 1318 may be a module which is used to better classify the offering to be listed on the custom media playlist 1128 based on a preference data of the patron 1108.

Furthermore, a sample data of the particular item of the custom media playlist 1128 of FIG. 11 may be provided to the patron 1108 to increase a frequency of instances of the transaction of the particular item of the custom media playlist 1128. Also, a plurality of music files may be provided to the patron based on the preference data of the patron using the jukebox module 1206 of FIG. 12 of the media module 1112. Moreover, a plurality of movie files may be provided to the patron 1108 based on the preference data of the patron 1108 using the multiplex module 1208 of the media module 1112.

FIG. 14 is an exploded view of the merchandise module 1114 of FIG. 11, according to one embodiment. Particularly, in FIG. 14 illustrates a filter module 1402, a purchase module 1404, an admin module 1406, a type module 1408, a size module 1410, a graphic module 1412, a text module 1414, and/or a contribution module 1416. The filter module 1402 may enable the patron 1108 to stylize the customizable merchandise item 1130 (e.g., a t-shirt, a mug, etc.) based on a choice of the patron 1108. The purchase module 1404 may allow the patron 1108 to complete a transaction of any item of the customizable merchandise item 1130 without leaving the page view 1122.

The admin module 1406 may oversee a transaction taking place in the merchandise module 1114 of FIG. 11 and/or conduct an administrative function which may includes censoring of a contribution (e.g., of a graphic data and/or a text data) of the patron 1108. The type module 1408 may be used to list types (e.g., a sweat shirt, a long sleeve, etc.) of the customizable merchandise item 1130 (e.g., a t-shirt, etc.) available for sale. The size module 1410 may be used to list sizes (e.g., a small, a medium, a large, an extra large, etc.) of the customizable merchandise item 1130 (e.g., a t-shirt, etc.) available for sale. The graphic module 1412 may be used to list graphics (e.g., a picture, a symbol, a trademark, etc.) that may be applied (e.g., printed, painted, etc.) to the customizable merchandise item 1130 (e.g., a t-shirt, etc.) available for sale.

The text module 1414 may be used to list a list of texts (e.g., a logo, a catch phrase, etc.) that may be applied (e.g., printed, etched, etc.) to the customizable merchandise item 1130 (e.g., a t-shirt, etc.) available for sale. The contribution module 1416 may enable the patron 1108 and/or the publisher module 1104 to offer his/her own art (e.g., made up of a graphic data and a text data) to a pool of existing graphic data and text data of the publisher module 1104 (e.g., which may be offered through the distributor module 1102). However, the graphic data and the text data of the patron 1108 may be censored when the admin module 1406 find them to be offensive in nature (e.g., due to vulgarity, profanity, etc.).

Furthermore, a pool of the choice data (e.g., a type data, a size data, a graphic data, and/or a text data) may be expanded based on a contribution of the graphic data and the text data of the patron 1108 using a contribution module 1416 of the merchandise module 1114. The patron 1108 may be enabled to uniquely design a t-shirt based on the choice data using the t-shirt module 1210 of the merchandise module 1114. Also, the patron 1108 may be enabled to particularly design a mug based on the choice data using a mug module of the merchandise module 1114.

FIG. 15 is a user interface view of an electronic message associated with the electronic message module of FIG. 11, according to one embodiment. Particularly, in FIG. 15 illustrates an electronic message 1500, a header 1502, an attachment 1504, a body 1506, a message text 1508, an embedded offering 1512, a transaction information 1514, and/or a digital certificate 1516. The electronic message 1500 may be a medium (e.g., through an email and/or other electronic messaging systems) which may be electronically communicated to a recipient (e.g., the patron 1108 of FIG. 11). The header 1502 may contain information of a sender, a receiver, a subject, and a date of the electronic message 1500. The attachment 1504 may be a computer file (e.g., of the custom media playlist 1128 and/or the customizable merchandise item 1130) which may be sent to a recipient along with the electronic message 1500.

The body 1506 may be message portion of the electronic message 1500. The message text 1508 may be used to urge the recipient (e.g., the patron 1108) to buy an item embedded in the body 1506 of the electronic message 1500. The embedded offering 1512 may be embedded (e.g., through applying the commerce engine 1132 of the offering) in the body 1506. The transaction information 1514 may include a billing information, a shipping information, an order confirmation, and/or a place order. The transaction information 1514 may be presented to the recipient of the electronic message such that the recipient may be able to perform a transaction of the offering without any click-through. The digital certificate 1516 may ensure the recipient to perform a transaction of the offering without worrying about a security of the transaction.

Furthermore, the recipient may be enabled to transact the offering directly in the body 1506 (e.g., a message portion) of the electronic message 1500 without being redirected to another location away from the body 1506 of the electronic message 1500. The commerce engine 1132 (e.g., of FIG. 1) having the manifestation of the offering may be embedded in the attachment 1504 of the electronic message 1500. In addition, the digital certificate 1516 may be embedded on the body 1506 of the electronic message 1500 such that the recipient is assured of a security and a soundness in transacting the offering. The recipient of the electronic message 1500 may be enabled to forward the commerce engine 1132 to an acquaintance of the recipient such that the acquaintance makes a purchase of the offering without leaving the body 1506 of the electronic message 1500. Moreover, a profit of the purchase may be shared between the recipient and the distributor module 1102 when the acquaintance makes the purchase of the offering, wherein the recipient signs up with the distributor module 1102 to participate in the sharing the profit before the purchase takes place.

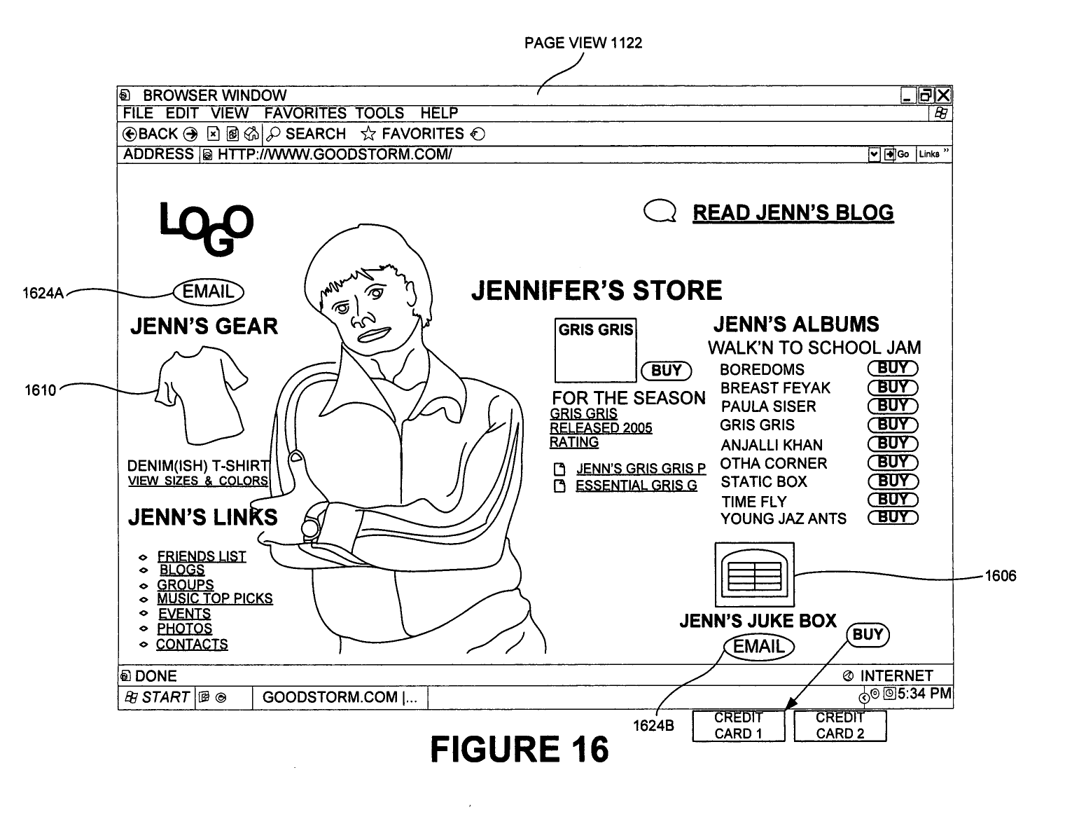

FIG. 16 is a user interface view of the page view 1122 of FIG. 11 associated with the publisher module 1104 of FIG. 11, according to one embodiment. Particularly, in FIG. 16 illustrates a jukebox 1606 (e.g., of the custom media playlist 1128 of FIG. 11), a t-shirt 1610 (e.g., of the customizable merchandise item 1130), and/or an email button 1624. The jukebox 1606 may be a representative of a collection of music being offered to the patron 1108. The jukebox 1606 may initially be populated with music files based on a criterion of the patron 1108 evidenced by personal information of the patron entered in a registration process of the publisher module 1104. Alternatively, the criterion may be determined based on a transaction history of the patron 1108.

The t-shirt 1610 may be a representative of a t-shirt being offered to the patron 1108. The t-shirt 1610 initially being displayed may be based on a profile (e.g., based on a personal value, a political value, a religious value, a professional value, a social value and/or a controversial value, etc.) of the publisher module 1104. The email button 1624 may be used to send a signal data to the delivery module 1116 of FIG. 11 which embeds the jukebox 1606 and/or the t-shirt 1610 to the body 1506 of FIG. 15 (e.g., a message portion) of the electronic message 1500 and/or communicates the electronic message 1500 to a recipient (e.g., the patron 1108). Furthermore, the commerce engine 1132 having a manifestation of an offering (e.g., the jukebox 1606 and/or the t-shirt 1610) may be embedded such that the recipient customizes the offering based on a preference.

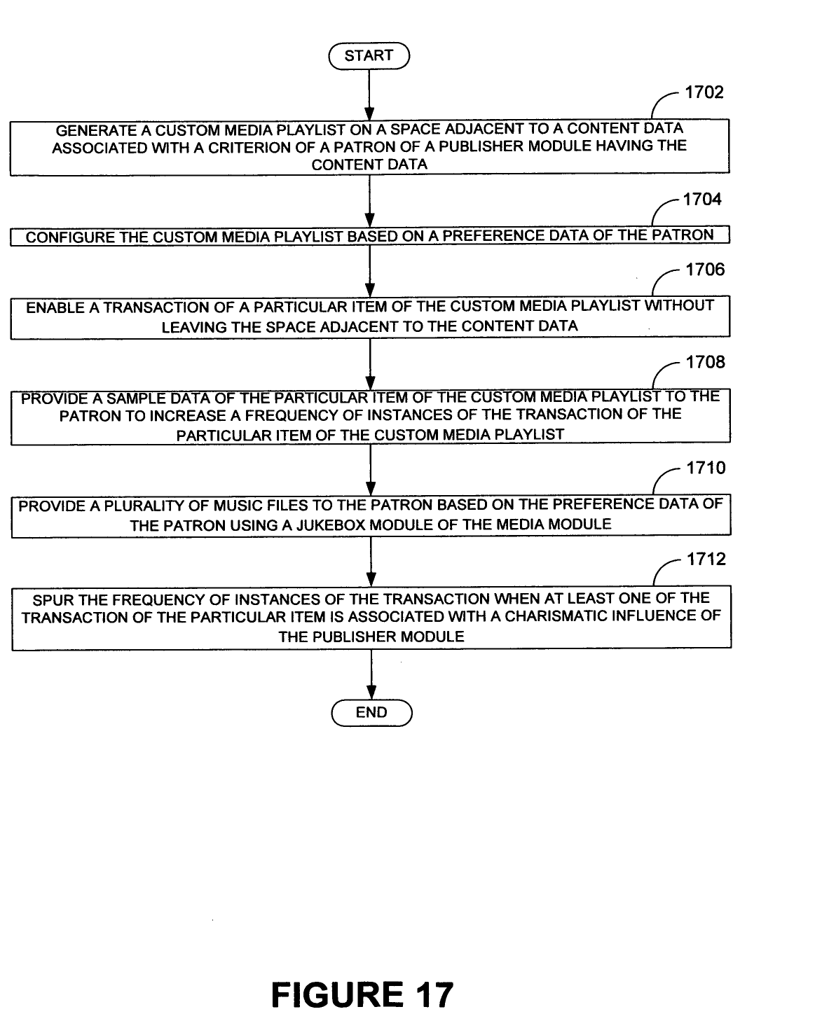

FIG. 17 is a process flow to provide a transaction of a custom media playlist without leaving the publisher module 1104 of FIG. 11, according to one embodiment. In operation 1702, a custom media playlist (e.g., the custom media playlist 1128 of FIG. 11) may be generated on a space adjacent to a content data (e.g., the content data 1126) associated with a criterion of a patron of a publisher module (e.g., the publisher module 1104) having the content data. In operation 1704, the custom media playlist may be configured based on a preference data of the patron (e.g., the patron 1108). A transaction of a particular item of the custom media playlist may be enabled without leaving the space adjacent to the content data in operation 1706. In operation 1708, a sample data of the particular item of the custom media playlist may be provided to the patron to increase a frequency of instances of the transaction of the particular item of the custom media playlist. A plurality of music files may be provided to the patron in operation 1710 based on the preference data of the patron using a jukebox module (e.g., the jukebox module 1206 of FIG. 12) of the media module (e.g., the media module 1112). In operation 1712, the frequency of instances of the transaction may be spurred when at least one of the transaction of the particular item is associated with a charismatic influence of the publisher module, wherein a profit of the transaction to be shared between the publisher module and the distributor module (e.g., the distributor module 1102).

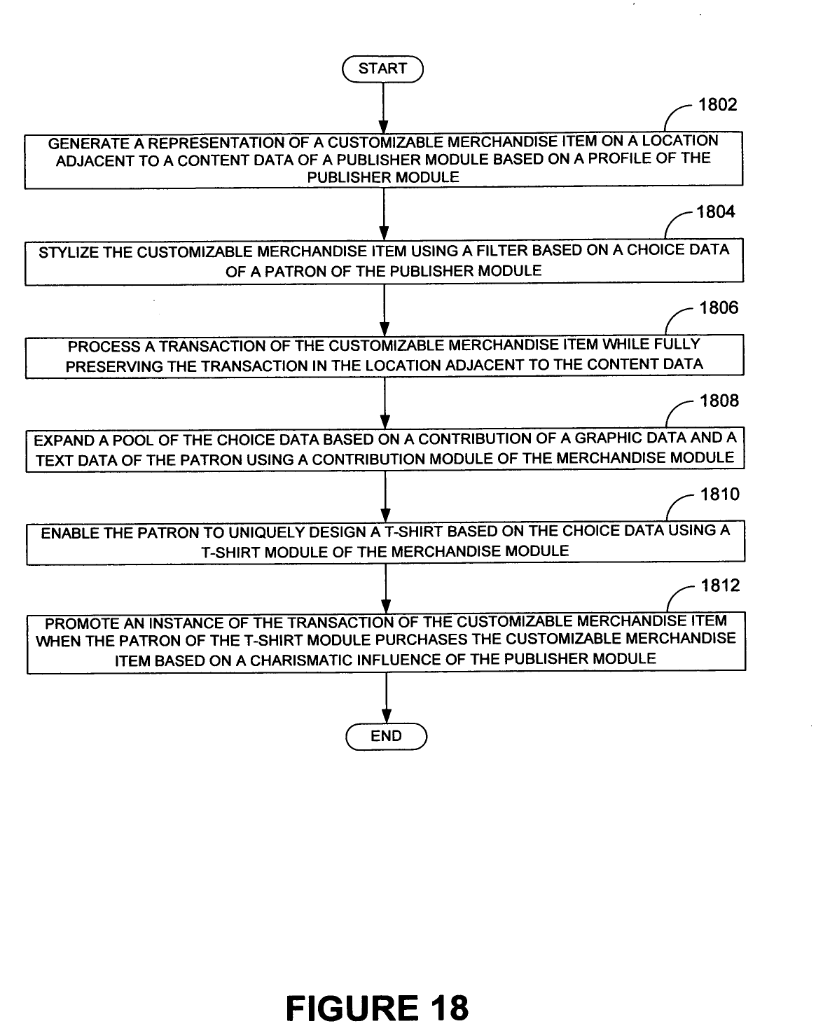

FIG. 18 is a process flow to process a transaction of the customizable merchandise item 1130 while fully preserving a network location of the publisher module 1104 of FIG. 11, according to one embodiment. In operation 1802, a representation of a customizable merchandise item (e.g., the customizable merchandise item 1130 of FIG. 11) may be generated on a location adjacent to a content data (e.g., the content data 1126) of a publisher module (e.g., the publisher module 1104) based on a profile of the publisher module. The customizable merchandise item may be stylized using a filter (e.g., the filter module 1402 of FIG. 14) based on a choice data of a patron (e.g., the patron 1108) of the publisher module in operation 1804.

In operation 1806, a transaction of the customizable merchandise item may be processed while fully preserving the transaction in the location adjacent to the content data. A pool of the choice data may be expanded in operation 1808 based on a contribution of the graphic data (e.g. the graphic module 1412 of FIG. 14) and the text data (e.g., the text module 1414 of FIG. 14) of the patron using a contribution module (e.g., the contribution module 1416) of a merchandise module (e.g., the merchandise module 1114). In operation 1810, the patron may be enabled to uniquely design a t-shirt based on the choice data using a t-shirt module (e.g., the t-shirt module 1210 of FIG. 12) of the merchandise module. In operation 1812, an instance of the transaction of the customizable merchandise item may be promoted when the patron of the t-shirt module purchases the customizable merchandise item based on a charismatic influence of the publisher module.

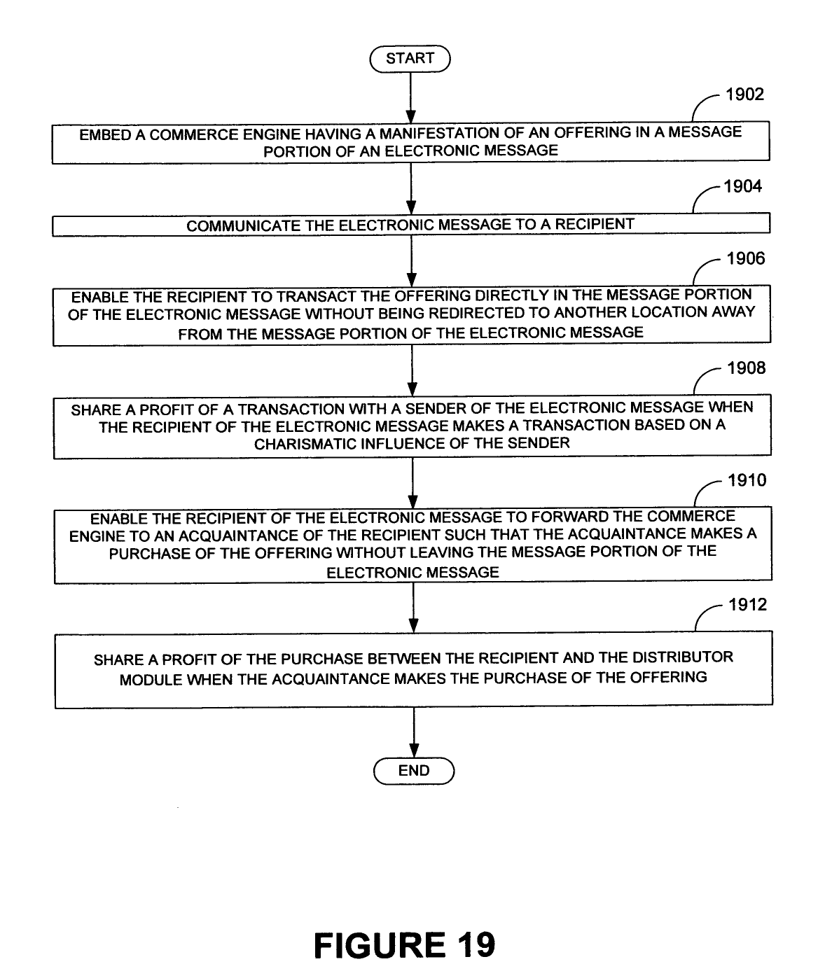

FIG. 19 is a process flow to enable a transaction of an offering in the body 1506 of the electronic message 1500 of FIG. 15, according to one embodiment. In operation 1902, a commerce engine (e.g., the commerce engine 1132 of FIG. 11) having a manifestation of an offering may be embedded in a message portion (e.g., the body 1506 of FIG. 15) of an electronic message (e.g., the electronic message 1500). The electronic message may be communicated to a recipient in operation 1904. The recipient may be enabled to transact the offering directly in the message portion of the electronic message without being redirected to another location away from the message portion of the electronic message in operation 1906. In operation 1908, a profit of a transaction may be shared with a sender of the electronic message when the recipient of the electronic message makes the transaction based on a charismatic influence of the sender. In operation 1910, the recipient of the electronic message may be enabled to forward the commerce engine to an acquaintance of the recipient such that the acquaintance makes a purchase of the offering without leaving the message portion of the electronic message. In operation 1912, a profit of the purchase between the recipient and the distributor module may be shared when the acquaintance makes the purchase of the offering.

For example, a patron of a blog (e.g., online diary) may be inclined to support an owner of the blog through purchasing an item (e.g., tangible and/or intangible) offered at the blog. The item may be a media file, a merchandise item, and/or other items. In one example embodiment, a list of music files may be populated in a representation of a jukebox (e.g., which may be displayed adjacent to a content data of the blog) when the patron clicks a button of the representation. Once the list is displayed, the patron may be able to enter a preference data (e.g., which may include a genre data, a topliner data, a period data, a popularity data, and/or an other data) to display music files of his/her choice. In addition, the patron may be enabled to make a transaction of the music files without leaving a pageview of the jukebox.

In an alternative example embodiment, a space adjacent to a content data of the blog (e.g., which may be on a same page and/or a different page with the content data) may be populated in a representation of a t-shirt when the patron clicks a button of the representation. Once the t-shirt is displayed, the patron may be able to enter a choice data (e.g., which may include a type data, a size data, a graphic data, and/or a text data) to display a t-shirt of his/her choice. In addition, the patron may be enabled to make a purchase of the t-shirt without leaving a pageview displaying the t-shirt. Furthermore, the patron may contribute his/her own design of the t-shirt and/or share a profit for his/her contribution with the owner of the blog.

In yet another alternative example embodiment, the owner may be allowed to send the representations of offerings (e.g., the jukebox with the music files, the t-shirt, etc.) to the patron using an electronic message (e.g., email) through applying the representations to a message portion of the electronic message. The patron may be able to make a transaction of the offerings without leaving the message portion of the electronic message. Furthermore, the patron may be able to forward the electronic message to his/her acquaintance. In addition, the representations of the offerings may be attached to the electronic message as well.

Although the present embodiments have been described with reference to specific example embodiments, it will be evident that various modifications and changes may be made to these embodiments without departing from the broader spirit and scope of the various embodiments. For example, the various devices, modules, engines, analyzers, generators, etc. described herein may be enabled and operated using hardware circuitry (e.g., CMOS based logic circuitry), firmware, software and/or any combination of hardware, firmware, and/or software (e.g., embodied in a machine readable medium).

For example, the service provider module 102, the admired party module 104, the follower device 112, the commerce engine 114, the enrollment module 200, the commerce engine generator module 202, the fulfillment module 204, the financial module 206, the customization module 212, the data analyzer 214, the virtual inventory module 216, the offering display module 218, the order processing module 220, the transaction module 222, the profit sharing module 224, the profit analyzer 226, the reporting module 228, the accounting module 230, the commerce engine module 300, the management module 304, the offering analyzer 306 and/or the setting module 308 may be enabled using transistors, logic gates, and electrical circuits (e.g., application specific integrated ASIC circuitry) using a service provider circuit, an admired party circuit, a follower circuit, a commerce engine, an enrollment circuit, a commerce engine circuit, a fulfillment circuit, a financial circuit, a customization circuit, a data circuit, a virtual inventory circuit, an offering display circuit, an order processing circuit, a transaction circuit, a profit sharing circuit, a profit circuit, a reporting circuit, an accounting circuit, a commerce engine circuit, a management circuit, an offering circuit and/or a setting circuit.

Furthermore, the distributor module 1102, the publisher module 1104, the vendor module 1110, the media module 1112, the merchandise module 1114, the delivery module 1116, the criterion module 1118, the profile module 1120, and/or the electronic message module 1124 of FIG. 11, the pop-in module 1202, the jukebox module 1206, the multiplex module 1208, the t-shirt module 1210, and/or the mug module 1212 of FIG. 12, the select module 1302, the sample module 1304, the management module 1306, the transaction module 1308, the genre module 1310, the topliner module 1312, the period module 1314, the popularity module 1316, and/or the other module 1318 of FIG. 13, and/or the filter module 1402, the purchase module 1404, the admin module 1406, the type module 1408, the size module 1410, the graphic module 1412, the text module 1414, and/or the contribution module 1416 of FIG. 14, may be enabled using transistors, logic gates, and electrical circuits (e.g., application specific integrated ASIC circuitry) using a distributor circuit, a publisher circuit, a vendor circuit, a media circuit, a merchandise circuit, a delivery circuit, a criterion circuit, a profile circuit, an electronic message circuit, a pop-in circuit, a jukebox circuit, a multiplex circuit, a t-shirt circuit, a mug circuit, a select circuit, a sample circuit, a management circuit, a transaction circuit, a genre circuit, a topliner circuit, a period circuit, a popularity circuit, an other circuit, a filter circuit, a purchase circuit, an admin circuit, a type circuit, a size circuit, a graphic circuit, a text circuit, and/or contribution circuit.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method of a media module of a distributor module, comprising:
generating a custom media playlist on a space adjacent to a content data associated with a criterion of a patron of a publisher module having the content data;
configuring the custom media playlist based on a preference data of the patron; and
enabling a transaction of a particular item of the custom media playlist without leaving the space adjacent to the content data.

2. The method of claim 1 wherein the preference data is at least one of a genre data, a topliner data, a period data, a popularity data, and an other data.

3. The method of claim 2 further comprising providing a sample data of the particular item of the custom media playlist to the patron to increase a frequency of instances of the transaction of the particular item of the custom media playlist.

4. The method of claim 3 further comprising providing a plurality of music files to the patron based on the preference data of the patron using a jukebox module of the media module.

5. The method of claim 4 further comprising spurring the frequency of instances of the transaction when at least one of the transaction of the particular item is associated with a charismatic influence of the publisher module, wherein a profit of the transaction to be shared between the publisher module and the distributor module.

6. The method of claim 3 further comprising providing a plurality of movie files to the patron based on the preference data of the patron using a multiplex module of the media module.

7. The method of claim 1 in a form of a machine-readable medium embodying a set of instructions that, when executed by a machine, causes the machine to perform the method of claim 1.

8. A method of a merchandise module of a distributor module, comprising:
generating a representation of a customizable merchandise item on a location adjacent to a content data of a publisher module based on a profile of the publisher module;
stylizing the customizable merchandise item using a filter based on a choice data of a patron of the publisher module; and
processing a transaction of the customizable merchandise item while fully preserving the transaction in the location adjacent to the content data.

9. The method of claim 8 wherein the choice data is at least one of a type data, a size data, a graphic data and a text data.

10. The method of claim 9 further comprising expanding a pool of the choice data based on a contribution of the graphic data and the text data of the patron using a contribution module of the merchandise module.

11. The method of claim 10 further comprising enabling the patron to uniquely design a t-shirt based on the choice data using a t-shirt module of the merchandise module.

12. The method of claim 11 further comprising promoting an instance of the transaction of the customizable merchandise item when the patron of the t-shirt module purchases the customizable merchandise item based on a charismatic influence of the publisher module.

13. The method of claim 10 further comprising enabling the patron to particularly design a mug based on the choice data using a mug module of the merchandise module.

14. A method of a delivery module of a distributor module, comprising:
embedding a commerce engine having a manifestation of an offering in a message portion of an electronic message;
communicating the electronic message to a recipient; and
enabling the recipient to transact the offering directly in the message portion of the electronic message without being redirected to another location away from the message portion of the electronic message.

15. The method of claim 14 further comprising embedding the commerce engine having the manifestation of the offering in an attachment of the electronic message.

16. The method of claim 15 further comprising embedding a digital signature on the message portion of the electronic message such that the recipient is assured of a security and a soundness in transacting the offering.

17. The method of claim 16 further comprising sharing a profit of a transaction with a sender of the electronic message when the recipient of the electronic message makes the transaction based on a charismatic influence of the sender, wherein an existence of the charismatic influence is predetermined based on an agreement between the sender and the distributor module.

18. The method of claim 17 further comprising enabling the recipient of the electronic message to forward the commerce engine to an acquaintance of the recipient such that the acquaintance makes a purchase of the offering without leaving the message portion of the electronic message.

19. The method of claim 18 further sharing a profit of the purchase between the recipient and the distributor module when the acquaintance makes the purchase of the offering, wherein the recipient signs up with the distributor module to participate in the sharing the profit before the purchase takes place.

20. The method of claim 19 further comprising performing the embedding the commerce engine having the manifestation of the offering such that the recipient customizes the offering based on a performance.
